(19) United States
(12) Patent Application Publication
(10) Pub. No.: US 2026/0358668 A1
(43) Pub. Date: Nov. 12, 2026

(54) DISPLAY SUBSTRATE AND DISPLAY DEVICE

(71) Applicant: Sharp Kabushiki Kaisha, Sakai City (JP)

(72) Inventors: Masamitsu YAMANAKA, Sakai City (JP); Yoshimasa CHIKAMA, Sakai City (JP); Kazuhiko IWASA, Sakai City (JP); Yutaka SAWAYAMA, Sakai City (JP); Shinji NAKAJIMA, Sakai City (JP)

(21) Appl. No.: 19/662,118

(22) Filed: Apr. 29, 2026

(30) Foreign Application Priority Data
May 12, 2025 (JP) 2025-079889

(51) Int. Cl. G02F 1/1685; G02F 1/167; G02F 1/16766

(52) U.S. Cl. CPC G02F 1/1685; G02F 1/167; G02F 1/16766

(57) ABSTRACT

A display substrate includes a plurality of pixel electrodes placed in a display region and an inspection pattern section being part of conductive layers constituting the plurality of pixel electrodes. In the plurality of pixel electrodes, there is a first pixel electrode having an opening and the inspection pattern section is placed within the opening of the first pixel electrode.

### CROSS-REFERENCE TO RELATED APPLICATIONS

This application claims the benefit of priority to Japanese Patent Application Number 2025-079889 filed on May 12, 2025. The entire contents of the above-identified application are hereby incorporated by reference.

### BACKGROUND

### Technical Field

The technology disclosed in the present specification relates to a display substrate and a display device that are designed to improve inspection accuracy.

Hitherto, there is a line width measurement element used for measuring a line width of a semiconductor product, and one example thereof is described in JP 2002-176083 A. The line width measurement element described in JP 2002-176083 A includes a plurality of wiring lines, four stylus terminals, and four lead wires, and each of the wiring lines is connected in parallel using the lead wires. By increasing the number of parallel wiring lines, influence of variations in wiring line resistance can be reduced without extending a wiring length.

### SUMMARY

The line width measurement element described in JP 2002-176083 A is placed in a scribe region outside a product region. This poses a problem of insufficient accuracy in measuring the line width of the wiring line to be measured, which is located near the center of the product region.

The technology described in the present specification has been made based on the circumstances described above, and aims to improve inspection accuracy.
(1) A display substrate according to the technology described in the present specification includes a plurality of pixel electrodes placed in a display region, and an inspection pattern section being part of conductive layers constituting the plurality of pixel electrodes, in which in the plurality of pixel electrodes, there is a first pixel electrode having an opening, and the inspection pattern section is placed within the opening of the first pixel electrode.
(2) In addition to (1), the display substrate may include thin film transistors placed in the display region and connected to the plurality of pixel electrodes, and a first insulating film, in which each of the thin film transistors may include a gate electrode being part of a first metal layer placed below the first insulating film, a semiconductor portion being part of a semiconductor film placed above the first insulating film and overlapping the gate electrode, a source electrode being part of a second metal layer placed above the semiconductor film and connected to the semiconductor portion, and a drain electrode being part of the second metal layer, positioned at a first distance from the source electrode, and connected to the semiconductor portion and one of the plurality of pixel electrodes, and the inspection pattern section may include a first inspection pattern section including a first pattern component being part of the first metal layer, a second pattern component being part of the semiconductor film and overlapping the first pattern component, a third pattern component being part of the second metal layer and connected to the second pattern component, and a fourth pattern component being part of the second metal layer, positioned at the first distance from the third pattern component, and connected to the second pattern component.
(3) In addition to (2), the display substrate may include a second insulating film placed above the second metal layer, a first pixel electrode component placed above the second insulating film, being part of a third metal layer, the third metal layer being one of the conductive layers, and constituting part of one of the plurality of pixel electrodes, a third insulating film placed above the third metal layer, and a second pixel electrode component placed above the third insulating film, being part of a transparent electrode film, the transparent electrode film being one of the conductive layers, constituting part of one of the plurality of pixel electrodes, and overlapping the first pixel electrode component, in which the first inspection pattern section may include a fifth pattern component being part of the third metal layer and overlapping at least the first pattern component, and a sixth pattern component being part of the transparent electrode film and overlapping the fifth pattern component, and a first contact hole configured to connect the first pixel electrode component and the second pixel electrode component may be provided in the second insulating film at a position overlapping both the first pixel electrode component and the second pixel electrode component, and a second contact hole configured to connect the fifth pattern component and the sixth pattern component may be provided in the second insulating film at a position overlapping both the fifth pattern component and the sixth pattern component.
(4) In addition to (3), in the display substrate, the inspection pattern section may include a second inspection pattern section including a seventh pattern component being part of the second metal layer and an eighth pattern component being part of the transparent electrode film and overlapping the seventh pattern component, and a third contact hole configured to connect the second pixel electrode component and the drain electrode may be provided in the second insulating film and the third insulating film at a position overlapping both the second pixel electrode component and the drain electrode, and a fourth contact hole configured to connect the seventh pattern component and the eighth pattern component may be provided in the second insulating film and the third insulating film at a position overlapping both the seventh pattern component and the eighth pattern component.
(5) In addition to (4), the display substrate may include a third pixel electrode component being part of the first metal layer, the first metal layer being one of the conductive layers, constituting part of one of the plurality of pixel electrodes, and overlapping part of the drain electrode, in which the second inspection pattern section may include a ninth pattern component being part of the first metal layer and overlapping the seventh pattern component, and a fifth contact hole configured to connect the third pixel electrode component and the drain electrode may be provided in the first insulating film at a position overlapping both the third pixel electrode component and the drain electrode, and a sixth contact hole configured to connect the seventh pattern component and the ninth pattern component may be provided in the first insulating film at a position overlapping both the seventh pattern component and the ninth pattern component.
(6) A display device according to the technology described in the present specification includes the display substrate according to any one of (1) to (5), a counter substrate placed facing the display substrate, and a display layer sandwiched between the display substrate and the counter substrate and configured to display an image.
(7) In addition to (6), in the display device, the display layer may be an electronic paper layer including a plurality of microcapsules or micro-cups including charged particles, and the plurality of pixel electrodes may overlap the plurality of microcapsules or micro-cups, respectively.

According to the technology described in the present specification, inspection accuracy can be improved.

### BRIEF DESCRIPTION OF DRAWINGS

The disclosure will be described with reference to the accompanying drawings, wherein like numbers reference like elements.

FIG. 1 is a plan view of an electronic paper display according to a first embodiment.

FIG. 2 is a cross-sectional view illustrating a cross-sectional configuration of a microcapsule layer that constitutes part of the electronic paper display according to the first embodiment.

FIG. 3 is a circuit diagram illustrating an electrical configuration of an array substrate that constitutes part of the electronic paper display according to the first embodiment.

FIG. 4 is a plan view illustrating a pixel array of the array substrate according to the first embodiment.

FIG. 5 is a cross-sectional view of the array substrate according to the first embodiment, taken along line v-v in FIG. 4.

FIG. 6 is a cross-sectional view illustrating a connection structure between a first pixel electrode component and a second pixel electrode component in the array substrate according to the first embodiment.

FIG. 7 is a cross-sectional view of the array substrate according to the first embodiment, taken along line vii-vii in FIG. 4.

FIG. 8 is a cross-sectional view of the array substrate according to the first embodiment, taken along line viii-viii in FIG. 4.

FIG. 9 is a cross-sectional view of the array substrate according to the first embodiment, taken along line ix-ix in FIG. 4.

FIG. 10 is a plan view illustrating a first pixel electrode and an inspection pattern section provided in the array substrate according to the first embodiment.

FIG. 11 is a plan view illustrating positions of the inspection pattern sections provided in the array substrate according to the first embodiment.

FIG. 12 is a plan view illustrating positions of the inspection pattern sections provided in an array substrate base material including the array substrate according to the first embodiment.

FIG. 13A is a plan view of a first inspection pattern section included in the inspection pattern section according to the first embodiment.

FIG. 13B is a plan view of a second inspection pattern section included in the inspection pattern section according to the first embodiment.

FIG. 13C is a plan view of a third inspection pattern section included in the inspection pattern section according to the first embodiment.

FIG. 14A is a cross-sectional view of the first inspection pattern section in the array substrate according to the first embodiment.

FIG. 14B is a cross-sectional view of the second inspection pattern section in the array substrate according to the first embodiment.

FIG. 14C is a cross-sectional view of the third inspection pattern section in the array substrate according to the first embodiment.

FIG. 15A is a plan view of the first inspection pattern section in the array substrate after a first step included in a method of manufacturing the array substrate according to the first embodiment.

FIG. 15B is a plan view of the second inspection pattern section in the array substrate after the first step included in the method of manufacturing the array substrate according to the first embodiment.

FIG. 15C is a plan view of the third inspection pattern section in the array substrate after the first step included in the method of manufacturing the array substrate according to the first embodiment.

FIG. 16A is a cross-sectional view of the first inspection pattern section in the array substrate after the first step included in the method of manufacturing the array substrate according to the first embodiment.

FIG. 16B is a cross-sectional view of the second inspection pattern section in the array substrate after the first step included in the method of manufacturing the array substrate according to the first embodiment.

FIG. 16C is a cross-sectional view of the third inspection pattern section in the array substrate after the first step included in the method of manufacturing the array substrate according to the first embodiment.

FIG. 17A is a plan view of the first inspection pattern section in the array substrate after a second step and a third step included in the method of manufacturing the array substrate according to the first embodiment.

FIG. 17B is a plan view of the second inspection pattern section in the array substrate after the second step and the third step included in the method of manufacturing the array substrate according to the first embodiment.

FIG. 17C is a plan view of the third inspection pattern section in the array substrate after the second step and the third step included in the method of manufacturing the array substrate according to the first embodiment.

FIG. 18A is a cross-sectional view of the first inspection pattern section in the array substrate after the second step and the third step included in the method of manufacturing the array substrate according to the first embodiment.

FIG. 18B is a cross-sectional view of the second inspection pattern section in the array substrate after the second step and the third step included in the method of manufacturing the array substrate according to the first embodiment.

FIG. 18C is a cross-sectional view of the third inspection pattern section in the array substrate after the second step and the third step included in the method of manufacturing the array substrate according to the first embodiment.

FIG. 19A is a plan view of the first inspection pattern section in the array substrate after a fourth step included in the method of manufacturing the array substrate according to the first embodiment.

FIG. 19B is a plan view of the second inspection pattern section in the array substrate after the fourth step included in the method of manufacturing the array substrate according to the first embodiment.

FIG. 19C is a plan view of the third inspection pattern section in the array substrate after the fourth step included in the method of manufacturing the array substrate according to the first embodiment.

FIG. 20A is a cross-sectional view of the first inspection pattern section in the array substrate after the fourth step included in the method of manufacturing the array substrate according to the first embodiment.

FIG. 20B is a cross-sectional view of the second inspection pattern section in the array substrate after the fourth step included in the method of manufacturing the array substrate according to the first embodiment.

FIG. 20C is a cross-sectional view of the third inspection pattern section in the array substrate after the fourth step included in the method of manufacturing the array substrate according to the first embodiment.

FIG. 21A is a plan view of the first inspection pattern section in the array substrate after a fifth step included in the method of manufacturing the array substrate according to the first embodiment.

FIG. 21B is a plan view of the second inspection pattern section in the array substrate after the fifth step included in the method of manufacturing the array substrate according to the first embodiment.

FIG. 21C is a plan view of the third inspection pattern section in the array substrate after the fifth step included in the method of manufacturing the array substrate according to the first embodiment.

FIG. 22A is a cross-sectional view of the first inspection pattern section in the array substrate after the fifth step included in the method of manufacturing the array substrate according to the first embodiment.

FIG. 22B is a cross-sectional view of the second inspection pattern section in the array substrate after the fifth step included in the method of manufacturing the array substrate according to the first embodiment.

FIG. 22C is a cross-sectional view of the third inspection pattern section in the array substrate after the fifth step included in the method of manufacturing the array substrate according to the first embodiment.

FIG. 23A is a plan view of the first inspection pattern section in the array substrate after a sixth step included in the method of manufacturing the array substrate according to the first embodiment.

FIG. 23B is a plan view of the second inspection pattern section in the array substrate after the sixth step included in the method of manufacturing the array substrate according to the first embodiment.

FIG. 23C is a plan view of the third inspection pattern section in the array substrate after the sixth step included in the method of manufacturing the array substrate according to the first embodiment.

FIG. 24A is a cross-sectional view of the first inspection pattern section in the array substrate after the sixth step included in the method of manufacturing the array substrate according to the first embodiment.

FIG. 24B is a cross-sectional view of the second inspection pattern section in the array substrate after the sixth step included in the method of manufacturing the array substrate according to the first embodiment.

FIG. 24C is a cross-sectional view of the third inspection pattern section in the array substrate after the sixth step included in the method of manufacturing the array substrate according to the first embodiment.

FIG. 25A is a plan view of the first inspection pattern section in the array substrate after a seventh step included in the method of manufacturing the array substrate according to the first embodiment.

FIG. 25B is a plan view of the second inspection pattern section in the array substrate after the seventh step included in the method of manufacturing the array substrate according to the first embodiment.

FIG. 25C is a plan view of the third inspection pattern section in the array substrate after the seventh step included in the method of manufacturing the array substrate according to the first embodiment.

FIG. 26A is a cross-sectional view of the first inspection pattern section in the array substrate after the seventh step included in the method of manufacturing the array substrate according to the first embodiment.

FIG. 26B is a cross-sectional view of the second inspection pattern section in the array substrate after the seventh step included in the method of manufacturing the array substrate according to the first embodiment.

FIG. 26C is a cross-sectional view of the third inspection pattern section in the array substrate after the seventh step included in the method of manufacturing the array substrate according to the first embodiment.

FIG. 27A is a plan view of the first inspection pattern section in the array substrate after an eighth step included in the method of manufacturing the array substrate according to the first embodiment.

FIG. 27B is a plan view of the second inspection pattern section in the array substrate after the eighth step included in the method of manufacturing the array substrate according to the first embodiment.

FIG. 27C is a plan view of the third inspection pattern section in the array substrate after the eighth step included in the method of manufacturing the array substrate according to the first embodiment.

FIG. 28A is a cross-sectional view of the first inspection pattern section in the array substrate after the eighth step included in the method of manufacturing the array substrate according to the first embodiment.

FIG. 28B is a cross-sectional view of the second inspection pattern section in the array substrate after the eighth step included in the method of manufacturing the array substrate according to the first embodiment.

FIG. 28C is a cross-sectional view of the third inspection pattern section in the array substrate after the eighth step included in the method of manufacturing the array substrate according to the first embodiment.

### DESCRIPTION OF EMBODIMENTS

### First Embodiment

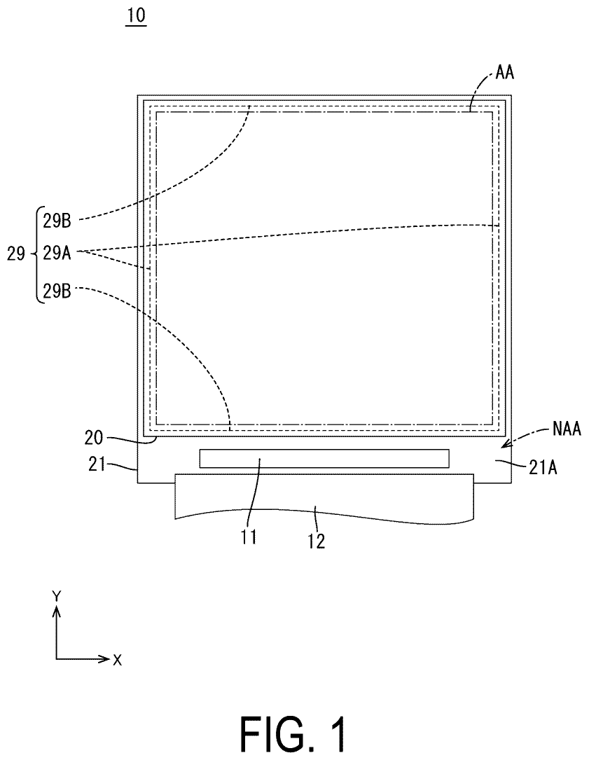

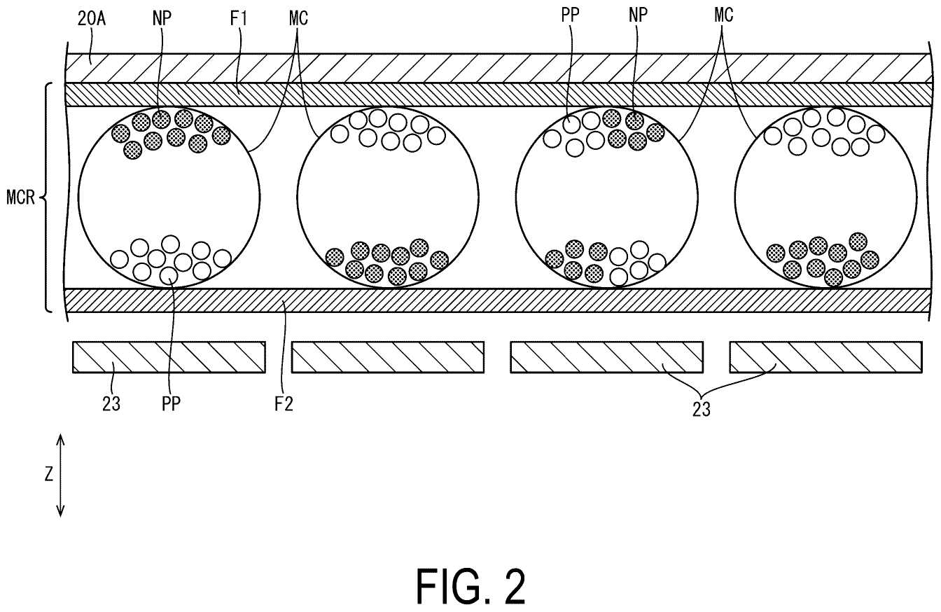

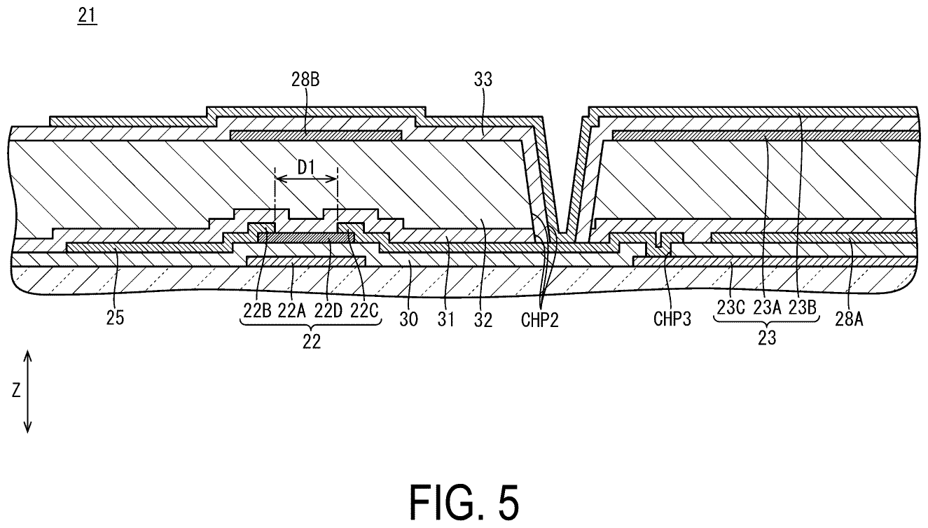

A first embodiment will be described with reference to FIGS. 1 to 28C. In the present embodiment, an electronic paper display (display device, EPD) 10 will be illustrated. Note that each drawing illustrates an X-axis, a Y-axis, and a Z-axis, and each direction of each axis is drawn so as to be common in all the drawings. An upper side in each of FIG. 2, FIGS. 5 to 9, and FIGS. 14A to 14C is referred to as a front side, and a lower side in each of the same figures is referred to as a rear side.

As illustrated in FIG. 1, the electronic paper display 10 has a vertically long rectangular shape. In the present embodiment, the electronic paper display 10 is operated by a microcapsule type electrophoretic method. A central portion of a main surface of the electronic paper display 10 is a display region AA in which images are displayed. On the other hand, a frame-shaped outer peripheral portion surrounding the display region AA of the main surface of the electronic paper display 10 is a non-display region NAA in which no images are displayed.

As illustrated in FIG. 1, the electronic paper display 10 includes an array substrate (display substrate) 21, which is a backplane, and a counter substrate 20 bonded to a front side of the array substrate 21 so as to face the front side. The counter substrate 20 and the array substrate 21 each include, for example, a substantially transparent glass substrate. As illustrated in FIG. 2, a microcapsule layer (display layer) MCR containing microcapsules MC in which charged particles are encapsulated is interposed between the counter substrate 20 and the array substrate 21. Note that both substrates 20 and 21 are not illustrated in FIG. 2. The microcapsule layer MCR includes a pair of films F1 and F2, and a large number of microcapsules MC sandwiched between the films F1 and F2. The microcapsule MC contains at least positively charged particles PP (e.g., titanium oxide particles, etc.), which are white pigments and positively charged, and negatively charged particles NP (e.g., carbon black particles, etc.), which are black pigments and negatively charged. Further, a counter electrode 20A is provided on an inner face side of the counter substrate 20 (a side of a face facing the array substrate 21). The counter electrode 20A is made of a transparent electrode material and is formed in a solid shape on the inner face of the counter substrate 20 so as to extend over at least the entire display region AA. The counter electrode 20A, which will be described in detail below, is positioned to face a plurality of pixel electrodes 23 provided in the array substrate 21 with the microcapsule layer MCR interposed therebetween.

As illustrated in FIG. 1, a short side and a long side of the counter substrate 20 are shorter than a short side and a long side of the array substrate 21, respectively. The counter substrate 20 is positioned to one side in a Y-axis direction (upper side in FIG. 1) relative to the array substrate 21. Therefore, the array substrate 21 has a frame-shaped portion 21A that is exposed without being covered with the counter substrate 20, and a side portion of the frame-shaped portion 21A on another side in the Y-axis direction (lower side in FIG. 1) is wider than a side portion on the one side. On the wider side portion of the frame-shaped portion 21A of the array substrate 21, a driver 11 and a flexible substrate 12 for supplying various signals are mounted, as described below. The non-display region NAA includes at least the entire frame-shaped portion 21A of the array substrate 21 and a portion of the counter substrate 20 that surrounds the display region AA. The display region AA has a square shape slightly smaller than the counter substrate 20. A frame-shaped capacitance trunk wiring line (common trunk wiring line) 29 that is slightly larger than the display region AA and slightly smaller than the counter substrate 20 is provided in the array substrate 21 at a portion that is covered with the counter substrate 20. The capacitance trunk wiring line 29 includes a pair of first trunk wiring line components 29A extending along the Y-axis direction and a pair of second trunk wiring line components 29B extending along an X-axis direction, and each of ends of the first trunk wiring line components 29A and each of ends of the second trunk wiring line components 29B are connected to each other.

The driver 11 is an LSI chip having a drive circuit therein. The driver 11 processes various signals transmitted by the flexible substrate 12. The driver 11 is placed in the wider side portion of the frame-shaped portion 21A of the array substrate 21, adjacent to one side of the display region AA in the Y-axis direction (lower side in FIG. 1) and is interposed between the flexible substrate 12 and the display region AA in the Y-axis direction. The driver 11 can supply various signals to various wiring lines and the like provided in the array substrate 21. The flexible substrate 12 has a configuration in which a wiring line pattern including a plurality of wiring lines is formed on a base material made of a synthetic resin material (for example, a polyimide resin) having insulating properties and flexibility. One end of the flexible substrate 12 is connected to the frame-shaped portion 21A of the array substrate 21, and another end is connected to an external circuit substrate (such as a control substrate).

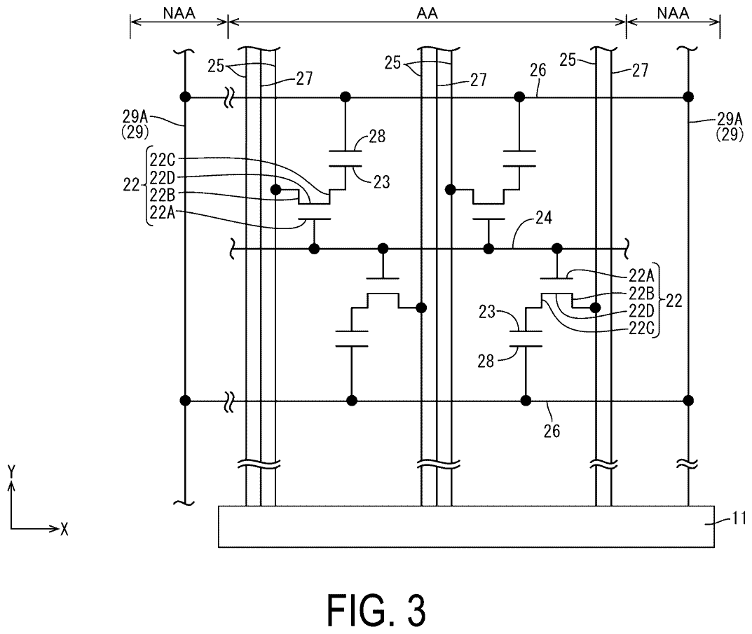

Next, an electrical configuration of the array substrate 21 will be described with reference to FIG. 3. As illustrated in FIG. 3, at least thin film transistors (TFTs, switching elements) 22 and the pixel electrodes 23 are provided on an inner face side of the array substrate 21 in the display region AA. A plurality of TFTs 22 and the plurality of pixel electrodes 23 are provided in a matrix shape with spaces therebetween along the X-axis direction and the Y-axis direction. Around the TFTs 22 and the pixel electrodes 23, gate wiring lines (scanning wiring lines) 24, source wiring lines (image wiring lines, signal wiring lines) 25, capacitance branch wiring lines 26, and gate connection wiring lines 27 orthogonal to (intersecting) each other are placed. The TFT 22 includes a gate electrode 22A connected to the gate wiring line 24, a source electrode 22B connected to the source wiring line 25, a drain electrode 22C connected to the pixel electrode 23, and a semiconductor portion 22D connected to the source electrode 22B and the drain electrode 22C. The TFT 22 is driven based on a scanning signal supplied to the gate electrode 22A via the gate wiring line 24. Then, a potential related to an image signal supplied to the source electrode 22B via the source wiring line 25 is supplied to the drain electrode 22C via the semiconductor portion 22D. As a result, the pixel electrode 23 is charged to the potential in accordance with the image signal. Note that the scanning signal has a potential higher than a threshold voltage of the TFT 22. A capacitance electrode 28 that forms an electrostatic capacitance together with the pixel electrode 23 is provided on the inner face side of the array substrate 21 in the display region AA. On the inner face side of the array substrate 21 in the non-display region NAA, the already-mentioned capacitance trunk wiring line 29 is provided.

As illustrated in FIG. 3, the gate wiring line 24 and the capacitance branch wiring line 26 both extend along the X-axis direction (first direction). The gate wiring lines 24 and the capacitance branch wiring lines 26 are arranged to be spaced and alternately repeated in the Y-axis direction (a second direction intersecting the first direction). Between the gate wiring line 24 and the capacitance branch wiring line 26 that are adjacent to each other spaced apart in the Y-axis direction, one TFT 22 and one pixel electrode 23 are interposed. The number of gate wiring lines 24 installed and the number of capacitance branch wiring lines 26 installed are each set to about half the number of pixel electrodes 23 arranged in the Y-axis direction. The gate wiring line 24 is connected to the gate electrodes 22A of the TFTs 22 in the display region AA. The gate wiring line 24 is connected to the gate electrode 22A of the TFT 22 connected to the pixel electrode 23 located on an upper stage side of the gate wiring line 24 (upper side in FIG. 3), and the gate electrode 22A of the TFT 22 connected to the pixel electrode 23 located on a lower stage side of the gate wiring line 24 (lower side in FIG. 3). That is, a scanning signal is supplied via one gate wiring line 24 to the gate electrodes 22A of each of the TFTs 22 connected to each of the pixel electrodes 23 placed in two rows adjacent in the Y-axis direction.

As illustrated in FIG. 3, the capacitance branch wiring lines 26 are placed across the display region AA and the non-display region NAA, and are connected to the capacitance electrodes 28 in the display region AA. Ends of the capacitance branch wiring line 26 that are drawn out to the non-display region NAA are connected to the first trunk wiring line components 29A of the capacitance trunk wiring line 29. All the capacitance branch wiring lines 26 that are arranged with spaces in the Y-axis direction are connected to the first trunk wiring line components 29A. A predetermined reference potential signal (common potential signal) is supplied from the first trunk wiring line components 29A to the capacitance branch wiring lines 26. Accordingly, the reference potential signal from the first trunk wiring line component 29A is supplied to the capacitance electrodes 28 via the capacitance branch wiring lines 26. Note that the capacitance trunk wiring line 29 is connected to the driver 11 or the flexible substrate 12, and is supplied with a reference potential signal from the driver 11 or an external circuit substrate. The capacitance electrode 28 to which the reference potential signal is supplied from the capacitance branch wiring line 26 forms an electrostatic capacitance together with the pixel electrode 23, thereby being able to maintain the potential of the charged pixel electrode 23. Both end portions of the capacitance branch wiring line 26 in the X-axis direction are connected to the first trunk wiring line components 29A.

As illustrated in FIG. 3, the source wiring lines 25 and the gate connection wiring lines 27 both extend along the Y-axis direction. Two source wiring lines 25 are disposed between the pixel electrodes 23 adjacent to each other in the X-axis direction. The source wiring lines 25 are also placed at positions spaced apart from the pixel electrodes 23 located at ends of the display region AA in the X-axis direction on the non-display region NAA sides. Therefore, the number of source wiring lines 25 installed is about twice the number of pixel electrodes 23 arranged in the X-axis direction. The source wiring lines 25 are placed across the display region AA and the non-display region NAA, and ends of portions of the source wiring lines 25 drawn out to the non-display region NAA are connected to the driver 11. Image signals are supplied to the source wiring lines 25 from the driver 11.

As illustrated in FIG. 3, the gate connection wiring lines 27 are arranged one by one between the pixel electrodes 23 adjacent to each other in the X-axis direction. The gate connection wiring line 27 placed between the pixel electrodes 23 adjacent to each other in the X-axis direction is interposed between the two source wiring lines 25 placed between the pixel electrodes 23 adjacent to each other in the X-axis direction. The gate connection wiring lines 27 are also placed at positions spaced apart from the source wiring lines 25 located at the ends of the display region AA in the X-axis direction on the non-display region NAA sides. The number of gate connection wiring lines 27 installed is substantially the same as the number of pixel electrodes 23 arranged in the X-axis direction, and is at least equal to or greater than the number of gate wiring lines 24 installed. The gate connection wiring lines 27 are placed across the display region AA and the non-display region NAA, and are connected to the gate wiring lines 24 in the display region AA. One or more gate connection wiring lines 27 are connected to all the gate wiring lines 24 placed in the display region AA, respectively. Ends of the gate connection wiring lines 27 that are drawn out to the non-display region NAA are connected to the driver 11. Scanning signals are supplied to the gate connection wiring lines 27 from the driver 11. Accordingly, the scanning signal from the driver 11 is supplied to the gate wiring line 24 via the gate connection wiring line 27.

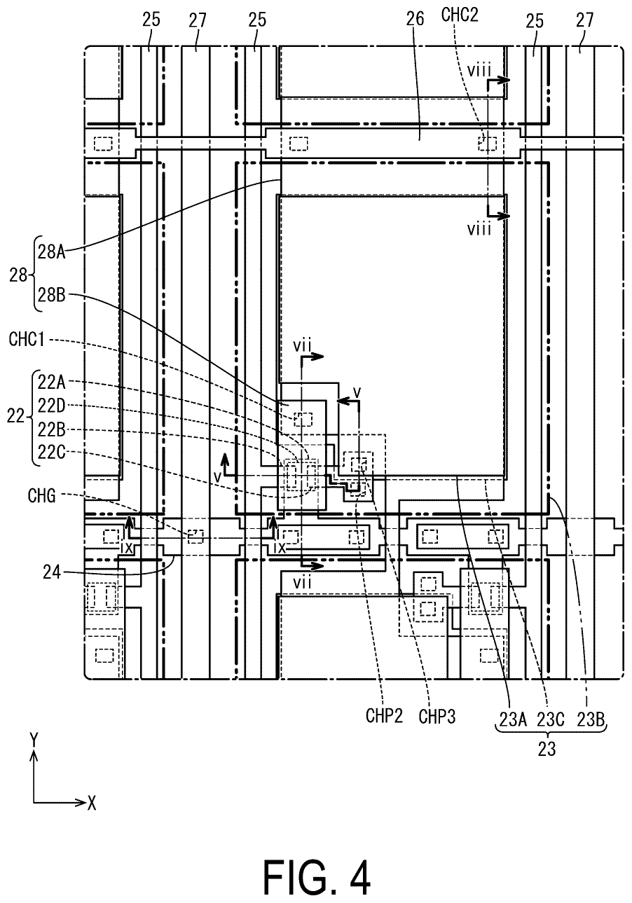

A detailed planar configuration of the array substrate 21 will be described with reference to FIG. 4. As illustrated in FIG. 4, the gate electrode 22A provided in the TFT 22 placed in the display region AA of the array substrate 21 is provided so as to extend along the Y-axis direction from a portion of the gate wiring line 24 near an intersection with the source wiring line 25. The source electrode 22B provided in the TFT 22 is provided so as to extend along the X-axis direction from a portion of the source wiring line 25 near the intersection with the gate wiring line 24. The source electrode 22B is placed at one end in the TFT 22 in the X-axis direction. The source electrode 22B overlaps part of the gate electrode 22A and is connected to the semiconductor portion 22D.

As illustrated in FIG. 4, the drain electrode 22C provided in the TFT 22 is placed at a position spaced a first distance D1 from the source electrode 22B in the X-axis direction, that is, at another end in the TFT 22 in the X-axis direction. The drain electrode 22C extends along the X-axis direction, and an end portion of the drain electrode 22C on a source electrode 22B side overlaps part of the gate electrode 22A and is connected to the semiconductor portion 22D. An end portion of the drain electrode 22C opposite to the source electrode 22B side is connected to the pixel electrode 23. That is, the drain electrode 22C extends along the X-axis direction from a position overlapping part of the semiconductor portion 22D to a position overlapping part of the pixel electrode 23 (first pixel electrode component 23A described below). The semiconductor portion 22D provided in the TFT 22 has a horizontally elongated shape extending along the X-axis direction. The semiconductor portion 22D is placed to overlap the gate electrode 22A in a plan view. One end portion of the semiconductor portion 22D in the X-axis direction is connected to the source electrode 22B, and another end portion of the semiconductor portion 22D in the X-axis direction is connected to the drain electrode 22C. Note that there are two types of TFTs 22: the TFT 22 adjacent to the gate wiring line 24 on an upper side in FIG. 4 and the TFT 22 adjacent to the gate wiring line 24 on a lower side in FIG. 4, and these TFTs 22 are configured inverted vertically and horizontally in FIG. 4.

As illustrated in FIG. 4, the pixel electrode 23 placed in the display region AA of the array substrate 21 is positioned in a region surrounded by the gate wiring line 24, the capacitance branch wiring line 26, and the two source wiring lines 25. The pixel electrode 23 has a substantially vertically long rectangular shape. The pixel electrode 23 has excellent light reflectivity and is placed to face the counter electrode 20A provided in the counter substrate 20 (see FIG. 1) with the microcapsule layer MCR interposed therebetween. When the pixel electrode 23 is charged, the charged particles NP and PP move within the microcapsule MC according to the polarity and potential of the pixel electrode 23. Light incident on the microcapsule layer MCR from outside the electronic paper display 10 through the counter substrate 20 is transmitted through or absorbed by the charged particles NP and PP located on the counter substrate 20 side in a Z-axis direction within the microcapsule MC. This controls an amount of reflected light for each pixel electrode 23, thereby enabling a predetermined image to be displayed in the display region AA. Note that a color image can be displayed by providing a color filter on the counter substrate 20.

As illustrated in FIG. 4, the capacitance electrode 28 extends along the Y-axis direction and is placed so as to overlap the plurality of pixel electrodes 23 aligned along the Y-axis direction in a plan view. The capacitance electrode 28 extends across at least two pixel electrodes 23 in the Y-axis direction, and overlaps these two pixel electrodes 23. In detail, the capacitance electrode 28 includes a capacitance electrode main body 28A that overlaps two pixel electrodes 23 interposed between two gate wiring lines 24 adjacent to each other, spaced apart in the Y-axis direction, and a covering portion 28B that overlaps part of the capacitance electrode main body 28A and covers part of the TFT 22. The capacitance electrode main body 28A extends along the Y-axis direction so as to extend over two pixel electrodes 23, and crosses the capacitance branch wiring line 26 extending along the X-axis direction. As will be described in detail below, the capacitance electrode main body 28A is connected to the capacitance branch wiring line 26 at a portion overlapping the capacitance branch wiring line 26. The plurality of capacitance electrode main bodies 28A are placed side by side with spaces along the Y-axis direction. The capacitance electrode main bodies 28A adjacent to each other in the Y-axis direction may be directly connected to each other. The number of capacitance electrode main bodies 28A arranged is about half the number of pixel electrodes 23 arranged in the Y-axis direction.

As illustrated in FIG. 4, the covering portion 28B extends along the Y-axis direction from a position overlapping part of the capacitance electrode main body 28A (a first capacitance contact hole CHC1 described below) toward the TFT 22 side, and covers at least the semiconductor portion 22D of the TFT 22. As will be described in detail below, the covering portion 28B is connected to the capacitance electrode main body 28A at a portion overlapping the capacitance electrode main body 28A. The covering portion 28B has a light blocking property to block light, thereby making it difficult for light to directly enter the semiconductor portion 22D. This makes it difficult for characteristics of the TFT 22 to deteriorate. The plurality of capacitance electrodes 28 having such a configuration are placed side by side with spaces along the X-axis direction.

As illustrated in FIG. 4, the capacitance branch wiring line 26 extends substantially straight along the X-axis direction in the display region AA, and is placed across all the capacitance electrodes 28 aligned along the X-axis direction. The capacitance branch wiring lines 26 are connected to all the capacitance electrodes 28 arranged along the X-axis direction. The capacitance branch wiring line 26 is connected to the first trunk wiring line components 29A of the capacitance trunk wiring line 29 in the non-display region NAA (see FIG. 3).

As illustrated in FIG. 4, the source wiring lines 25 and the gate connection wiring lines 27 both extend substantially straight along the Y-axis direction in the display region AA, and intersect all the gate wiring lines 24 and all the capacitance branch wiring lines 26 aligned along the Y-axis direction. The source wiring line 25 is placed at a position spaced apart from the pixel electrode 23 and the capacitance electrode 28 by a predetermined distance in the X-axis direction. The gate connection wiring line 27 is placed at a position spaced apart from the source wiring line 25 on an opposite side of the pixel electrode 23 and the capacitance electrode 28 in the X-axis direction. The gate connection wiring line 27 has a wider line width than the source wiring line 25.

Here, various layers and films layered on an inner face side of the array substrate 21 will be described with reference to FIG. 5. FIG. 5 is a cross-sectional view of the TFT 22 and a vicinity of the TFT 22 in the array substrate 21. As illustrated in FIG. 5, in the array substrate 21, at least a first metal layer (conductive layer), a gate insulating film (first insulating film) 30, a semiconductor film, a second metal layer (conductive layer), a first interlayer insulating film (second insulating film) 31, a flattening film (second insulating film) 32, a third metal layer (conductive layer), a second interlayer insulating film (third insulating film) 33, and a transparent electrode film (conductive layer) are layered in this order from a lower layer side (glass substrate side).

The first metal layer, the second metal layer, and the third metal layer are each a single layer film made of one type of metal material selected from copper, titanium, aluminum, molybdenum, tungsten, and the like, or a layered film or alloy made of different types of metal materials, and thus have conductivity and light blocking properties. The first metal layer constitutes part of the pixel electrode 23, the gate wiring line 24, the gate electrode 22A of the TFT 22, part of the capacitance trunk wiring line 29, and the like. The second metal layer constitutes the source wiring line 25, the source electrode 22B and the drain electrode 22C of the TFT 22, the gate connection wiring line 27, part of the capacitance electrode 28, part of the capacitance trunk wiring line 29, and the like. The third metal layer constitutes part of the pixel electrode 23, the capacitance branch wiring line 26, part of the capacitance electrode 28, and the like.

The semiconductor film is made of an oxide semiconductor material and constitutes the semiconductor portion 22D of the TFT 22 and the like. The semiconductor film may contain, for example, at least one kind of metal element of In, Ga, and Zn, and for example, an In—Ga—Zn—O based semiconductor (for example, indium gallium zinc oxide) may be used. Here, the In—Ga—Zn—O based semiconductor is a ternary oxide of In (indium), Ga (gallium), and Zn (zinc), there is no particular limitation on a ratio (composition ratio) of In, Ga, and Zn, and examples of the ratio include In:Ga:Zn=2:2:1, In:Ga:Zn=1:1:1, In:Ga:Zn=1:1:2, and the like. The In—Ga—Zn—O based semiconductor used for the semiconductor film may be amorphous or crystalline. The semiconductor film may include another oxide semiconductor in place of the In—Ga—Zn—O based semiconductor. There may be included, for example, an In—Sn—Zn—O based semiconductor (for example, In₂O₃-SnO₂-ZnO; InSnZnO). The In—Sn—Zn—O based semiconductor is a ternary oxide of In (indium), Sn (tin), and Zn (zinc). Alternatively, the oxide semiconductor layer may include an In—W—Zn—O based semiconductor and an In—W—Sn—Zn—O based semiconductor containing tungsten (W), an In—Al—Zn—O based semiconductor, an In—Al—Sn—Zn—O based semiconductor, a Zn—O based semiconductor, an In—Zn—O based semiconductor, a Zn—Ti—O based semiconductor, a Cd—Ge—O based semiconductor, a Cd—Pb—O based semiconductor, CdO (cadmium oxide), a Mg—Zn—O based semiconductor, an In—Ga—Sn—O based semiconductor, an In—Ga—O based semiconductor, a Zr—In—Zn—O based semiconductor, a Hf—In—Zn—O based semiconductor, an Al—Ga—Zn—O based semiconductor, a Ga—Zn—O based semiconductor, an In—Ga—Zn—Sn—O based semiconductor, and the like. The oxide semiconductor material of the semiconductor film has a higher resistance value in a state where no voltage is applied (OFF state) than that of a polysilicon semiconductor material. Further, the oxide semiconductor material of the semiconductor film has higher electron mobility than that of an amorphous silicon semiconductor material.

The gate insulating film 30, the first interlayer insulating film 31, and the second interlayer insulating film 33 are each made of an inorganic material such as silicon nitride (SiNₓ) or silicon oxide (SiO₂). The gate insulating film 30 maintains the first metal layer on a lower side insulated from the semiconductor film and the second metal layer on an upper side. The first interlayer insulating film 31, together with the flattening film 32 described below, maintains the semiconductor film and the second metal layer on the lower side insulated from the third metal layer on the upper side. The second interlayer insulating film 33 maintains the third metal layer insulated from the transparent electrode film. The flattening film 32 is made of an organic material such as PMMA (acrylic resin). The flattening film 32 made of the organic material has a film thickness greater than any of the gate insulating film 30, the first interlayer insulating film 31, and the second interlayer insulating film 33, which are made of an inorganic material. Specifically, film thicknesses of the gate insulating film 30, the first interlayer insulating film 31, and the second interlayer insulating film 33 are, for example, several tens to several hundreds of nanometers, whereas a film thickness of the flattening film 32 is, for example, approximately 1 μm to 3 μm. The flattening film 32, together with the first interlayer insulating film 31, maintains the semiconductor film and the second metal layer on the lower side insulated from the third metal layer on the upper side.

Next, a cross-sectional configuration of the TFT 22 will be described. As illustrated in FIG. 5, the gate electrode 22A provided in the TFT 22 is part of the first metal layer. The semiconductor portion 22D provided in the TFT 22 is part of the semiconductor film and is superimposed on the gate electrode 22A with the gate insulating film 30 interposed therebetween on the upper side. The source electrode 22B provided in the TFT 22 is part of the second metal layer, and is in direct contact with one end portion of the semiconductor portion 22D in the X-axis direction from above. The drain electrode 22C provided in the TFT 22 is part of the second metal layer, and is in direct contact with another end portion of the semiconductor portion 22D in the X-axis direction from above.

A cross-sectional configuration of the pixel electrode 23 will be described. As illustrated in FIG. 5, the pixel electrode 23 includes the first pixel electrode component 23A that is part of the third metal layer, a second pixel electrode component 23B that is part of the transparent electrode film, and a third pixel electrode component 23C that is part of the first metal layer. Most of the first pixel electrode component 23A, most of the second pixel electrode component 23B, and most of the third pixel electrode component 23C overlap each other. Among these, the first pixel electrode component 23A is placed within a range spaced apart from the gate wiring line 24, the source wiring lines 25, the capacitance branch wiring line 26, and the covering portion 28B of the capacitance electrode 28, as illustrated in FIG. 4, and part of the first pixel electrode component 23A overlaps part of the end portion of the drain electrode 22C on the side opposite to the source electrode 22B side.

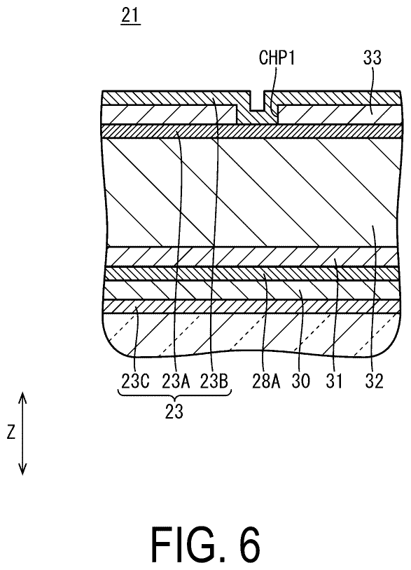

As illustrated in FIG. 4, the second pixel electrode component 23B overlaps entire regions of the first pixel electrode component 23A, the third pixel electrode component 23C, and the TFT 22, and in addition, overlaps parts of the two source wiring lines 25 that interpose the pixel electrode 23, but does not overlap the gate wiring line 24, the capacitance branch wiring line 26, or the gate connection wiring line 27. In detail, the second pixel electrode component 23B is placed in a range from the gate wiring line 24 to the capacitance branch wiring line 26 in the Y-axis direction, and is placed in a range interposed between two gate connection wiring lines 27 adjacent to two source wiring lines 25 that interpose the pixel electrode 23 in the X-axis direction. In the second interlayer insulating film 33 interposed between the first pixel electrode component 23A and the second pixel electrode component 23B, a first pixel contact hole (first contact hole) CHP1 is opened at a position overlapping both the first pixel electrode component 23A and the second pixel electrode component 23B, as illustrated in FIG. 6. The first pixel electrode component 23A and the second pixel electrode component 23B are connected through the first pixel contact hole CHP1. The second pixel electrode component 23B is located in the uppermost layer in the array substrate 21, and is positioned closer to the counter electrode 20A of the counter substrate 20 than the first pixel electrode component 23A and the third pixel electrode component 23C. Therefore, when the pixel electrode 23 is charged, an electrical field is generated between the third pixel electrode component 23C and the counter electrode 20A, which are faced to each other, and this electrical field can be used for displaying an image using the microcapsule layer MCR.

As illustrated in FIGS. 4 and 5, the second pixel electrode component 23B is placed such that part thereof overlaps substantially the entire region of the end portion of the drain electrode 22C on the side opposite to the source electrode 22B side. A second pixel contact hole (third contact hole) CHP2 is opened in the first interlayer insulating film 31, the flattening film 32, and the second interlayer insulating film 33 interposed between the second pixel electrode component 23B and the drain electrode 22C at a position overlapping both the second pixel electrode component 23B and the drain electrode 22C. The second pixel contact hole CHP2 is formed by communicating a lower side second pixel contact hole CHP2A provided in the first interlayer insulating film 31 and the flattening film 32 with an upper side second pixel contact hole CHP2B provided in the second interlayer insulating film 33. The second pixel electrode component 23B and the drain electrode 22C are connected through the second pixel contact hole CHP2.

As illustrated in FIGS. 4 and 5, the third pixel electrode component 23C, similarly to the first pixel electrode component 23A, is placed within a range spaced apart from the gate wiring line 24, the source wiring lines 25, the capacitance branch wiring line 26, and the covering portion 28B of the capacitance electrode 28, and part of the third pixel electrode component 23C overlaps part of the end portion of the drain electrode 22C on the side opposite to the source electrode 22B side. In detail, the third pixel electrode component 23C is placed so as not to overlap the second pixel contact hole CHP2. A third pixel contact hole (fifth contact hole) CHP3 is opened in the gate insulating film 30 interposed between the third pixel electrode component 23C and the drain electrode 22C at a position overlapping both the third pixel electrode component 23C and the drain electrode 22C and not overlapping the second pixel contact hole CHP2. The third pixel electrode component 23C and the drain electrode 22C are connected through the third pixel contact hole CHP3. The second pixel contact hole CHP2 and the third pixel contact hole CHP3 are placed side by side with a space therebetween in the Y-axis direction. In detail, the third pixel contact hole CHP3 is positioned farther from the semiconductor portion 22D than the second pixel contact hole CHP2 in the drain electrode 22C.

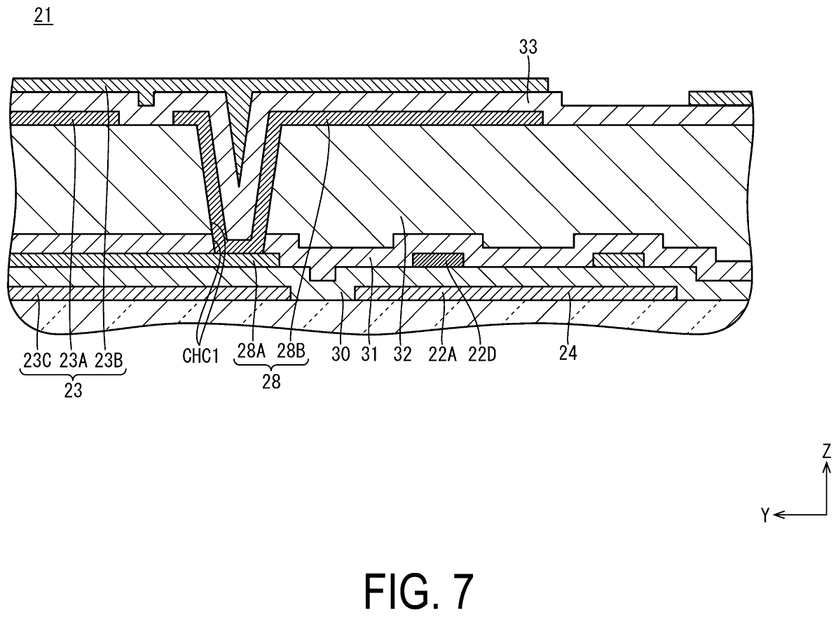

A cross-sectional configuration of the capacitance electrode 28 will be described. As illustrated in FIGS. 4 and 5, the capacitance electrode main body 28A is part of the second metal layer. The capacitance electrode main body 28A overlaps the third pixel electrode component 23C with the gate insulating film 30 interposed therebetween, and overlaps the first pixel electrode component 23A with the first interlayer insulating film 31 and the flattening film 32 interposed therebetween. That is, the capacitance electrode main body 28A is positioned between the third pixel electrode component 23C and the first pixel electrode component 23A in the Z-axis direction. Since electrostatic capacitances are formed between the capacitance electrode main body 28A and the third pixel electrode component 23C and between the capacitance electrode main body 28A and the first pixel electrode component 23A, the potential of the charged pixel electrode 23 can be maintained effectively. The covering portion 28B constituting part of the capacitance electrode 28 is part of the third metal layer. The covering portion 28B is placed to overlap the source electrode 22B, the drain electrode 22C, and the semiconductor portion 22D with the first interlayer insulating film 31 and the flattening film 32 interposed therebetween. The covering portion 28B can effectively block light that is to enter the semiconductor portion 22D (particularly, a portion constituting the channel region). As illustrated in FIG. 7, a first capacitance contact hole CHC1 is opened in the first interlayer insulating film 31 and the flattening film 32 interposed between the capacitance electrode main body 28A and the covering portion 28B at a position overlapping both the capacitance electrode main body 28A and the covering portion 28B. The capacitance electrode main body 28A and the covering portion 28B are connected through the first capacitance contact hole CHC1.

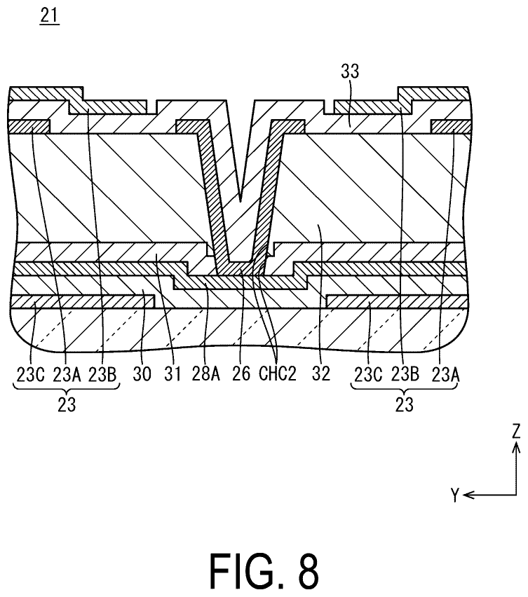

As illustrated in FIGS. 4 and 8, the capacitance branch wiring line 26 is part of the third metal layer. In the display region AA, the capacitance branch wiring line 26 extends along the X-axis direction and crosses the source wiring lines 25, the gate connection wiring lines 27, and the capacitance electrode main bodies 28A. In detail, the capacitance branch wiring line 26 intersects the source wiring lines 25, the gate connection wiring lines 27, and the capacitance electrode main bodies 28A with the first interlayer insulating film 31 and the flattening film 32 interposed therebetween, and intersects the gate connection wiring lines 27 with the gate insulating film 30 interposed therebetween. A second capacitance contact hole CHC2 is opened in the first interlayer insulating film 31 and the flattening film 32 interposed between the capacitance branch wiring line 26 and the capacitance electrode main body 28A at a position overlapping both the capacitance branch wiring line 26 and the capacitance electrode main body 28A. The capacitance branch wiring line 26 is connected to the capacitance electrode main body 28A through the second capacitance contact hole CHC2. The plurality of second capacitance contact holes CHC2 are placed at positions spaced apart in the X-axis direction.

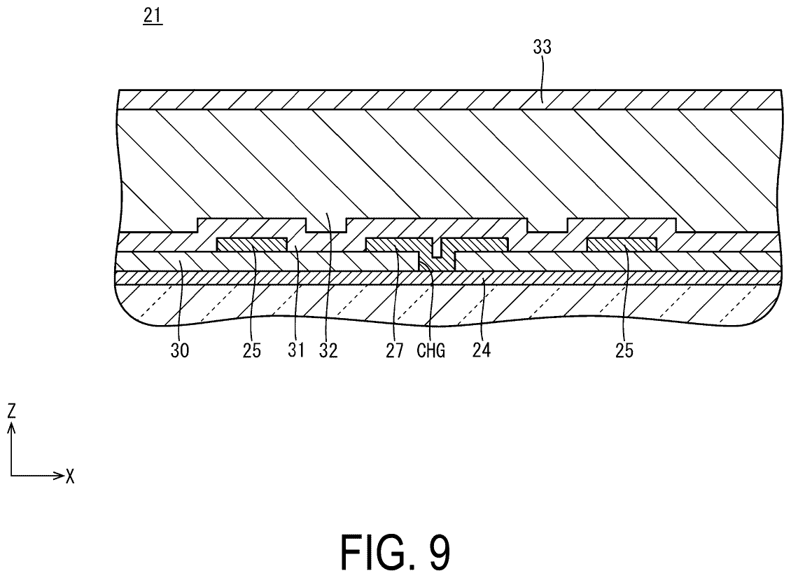

As illustrated in FIGS. 4 and 9, the gate wiring line 24 extends over substantially an entire length of the display region AA in the X-axis direction, and intersects the source wiring lines 25 and the gate connection wiring lines 27 with the gate insulating film 30 interposed therebetween. A gate contact hole CHG is opened in the gate insulating film 30 at a position overlapping both the gate connection wiring line 27 and the gate wiring line 24 that are to be connected to each other. The gate connection wiring line 27 is connected to the gate wiring line 24 to be connected through the gate contact hole CHG. No gate contact hole CHG is provided in the gate insulating film 30 at a position overlapping both the gate connection wiring line 27 and the gate wiring line 24 that are not to be connected to each other.

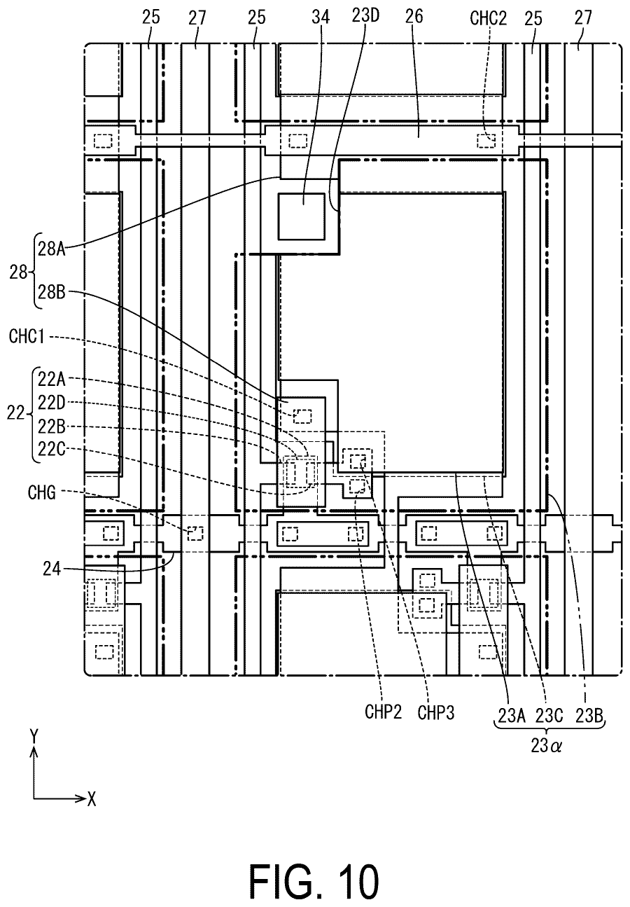

As illustrated in FIG. 10, some of the plurality of pixel electrodes 23 provided in the array substrate 21 according to the present embodiment include first pixel electrodes 23α having openings 23D. The opening 23D is provided by cutting out all of the first pixel electrode component 23A, the second pixel electrode component 23B, and the third pixel electrode component 23C that constitute the first pixel electrode 23α. In addition, among the plurality of capacitance electrode main bodies 28A, the capacitance electrode main body 28A that overlaps the first pixel electrode 23α is provided with a notch that communicates with the opening 23D at a position overlapping the opening 23D. An inspection pattern section 34 for inspecting structures provided in the array substrate 21 is placed within the opening 23D of the first pixel electrode 23α. The inspection pattern section 34 includes at least part of the conductive layers (the first metal layer, the third metal layer, and the transparent electrode film) that constitute the pixel electrode 23. Since the inspection pattern section 34 is placed within the opening 23D, the inspection pattern section 34 is positioned at a predetermined distance from the first pixel electrode component 23A, the second pixel electrode component 23B, and the third pixel electrode component 23C that constitute the first pixel electrode 23α. This prevents a short circuit between the inspection pattern section 34 and the first pixel electrode 23α. A size of the pixel electrode 23 is, for example, about 115 μm in the X-axis direction, and, for example, about 195 μm in the Y-axis direction. In contrast, a size of the opening 23D is, for example, about 30 μm in the X-axis direction and, for example, about 30 μm in the Y-axis direction, which is sufficiently smaller than the size of the pixel electrode 23. A size of the inspection pattern section 34 is, for example, about 22 μm in the X-axis direction and, for example, about 22 μm in the Y-axis direction, which is sufficiently smaller than the size of the pixel electrode 23. The inspection pattern section 34 and an opening edge of the opening 23D in the first pixel electrode 23α are spaced apart by, for example, about 7 μm to 8 μm in both the X-axis direction and the Y-axis direction.

Thus, the inspection pattern section 34 that is part of the conductive layers that constitute the pixel electrode 23 is placed within the opening 23D of the first pixel electrode 23α, so that by inspecting the inspection pattern section 34, it is possible to obtain information related to at least positions, dimensions, and the like in the pixel electrode 23. Compared to the existing method of performing inspection using only the inspection pattern section 34 located outside the display region AA, inspection accuracy is improved, and information regarding the pixel electrode 23, which is a structure located in the display region AA, can be obtained with high accuracy.

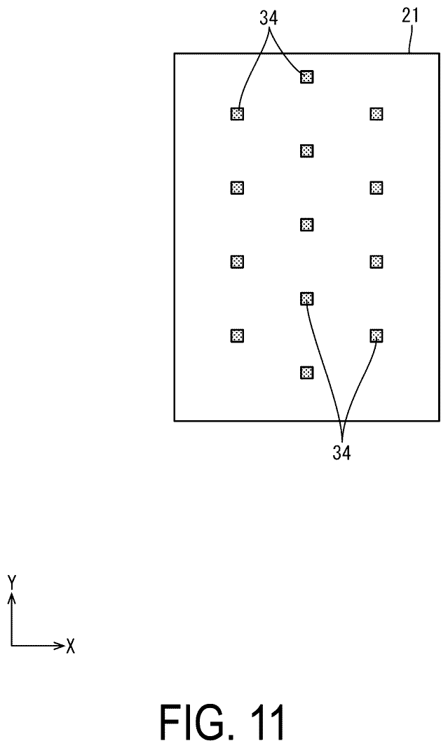

As illustrated in FIG. 11, the plurality of inspection pattern sections 34 are distributed and arranged in the display region AA of the array substrate 21. In detail, the inspection pattern sections 34 are arranged at a central position in the X-axis direction, a first intermediate position located at an intermediate position between the central position in the X-axis direction and one end position (left side in FIG. 11), and a second intermediate position located at an intermediate position between the central position in the X-axis direction and another end position (right side in FIG. 11), in the display region AA of the array substrate 21. Five inspection pattern sections 34 are arranged at substantially equal distances along the Y-axis direction at the central position in the X-axis direction. At each of the first intermediate position and the second intermediate position in the X-axis direction, four inspection pattern sections 34 are arranged at substantially equal distances along the Y-axis direction, and positions of the inspection pattern sections 34 in the Y-axis directions are shifted from the positions of the inspection pattern sections 34, arranged at the central position in the X-axis direction, in the Y-axis direction. That is, a total of 13 inspection pattern sections 34 provided in the display region AA of the array substrate 21 are dispersedly arranged in a zig-zag shape in a plan view. The positions and the number of first pixel electrodes 23α installed and openings 23D match the positions and the number of inspection pattern sections 34 installed described above. As described above, by performing the inspection using the total of 13 inspection pattern sections 34 that are dispersedly arranged in a zig-zag shape in the display region AA of the array substrate 21, information regarding the pixel electrodes 23 can be obtained with high accuracy at any position within the display region AA. Here, the first pixel electrode 23α has a smaller amount of transmitted light compared with the pixel electrode 23 that does not have the opening 23D, due to presence of the opening 23D. In contrast, the number of first pixel electrodes 23α installed is far less than the number of pixel electrodes 23 installed that have no openings 23D, and the first pixel electrodes 23α are dispersedly arranged in a zig-zag shape, so that the adverse effect of the openings 23D of the first pixel electrodes 23α on display quality is sufficiently reduced.

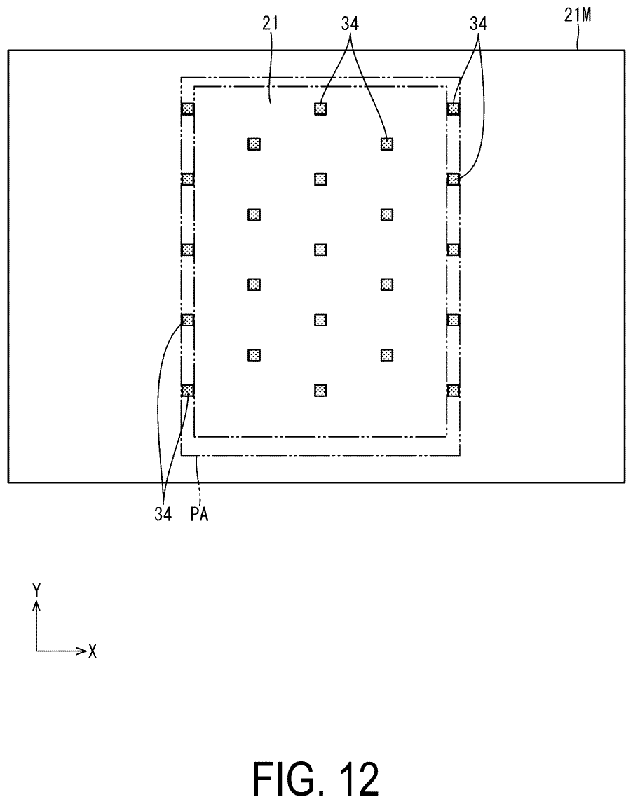

As illustrated in FIG. 12, the inspection pattern sections 34 are also provided in a region outside the array substrate 21 in an array substrate base material 21M used in a manufacturing process of the array substrate 21. In detail, the array substrate base material 21M is larger than the array substrate 21 and is fed into various manufacturing apparatuses used for manufacturing the array substrate 21. The array substrate 21 is taken out by scribing the array substrate base material 21M after all manufacturing steps are completed. A frame-shaped region in the array substrate base material 21M that surrounds the array substrate 21 is a pattern arrangement region PA in which the inspection pattern sections 34 are arranged. In the pattern arrangement region PA, there are no structures such as the pixel electrodes 23 that are placed in the display region AA. Five inspection pattern sections 34 are arranged at substantially equal distances along the Y-axis direction in each of two portions of the pattern arrangement region PA that extend along the Y-axis direction. The positions of the inspection pattern sections 34 arranged in the pattern arrangement region PA in the Y-axis direction substantially match the positions of the inspection pattern sections 34, at the central position of the display region AA in the X-axis direction, in the Y-axis direction. As described above, in the array substrate base material 21M, 13 inspection pattern sections 34 arranged in the array substrate 21 and 10 inspection pattern sections 34 arranged in the pattern arrangement region PA are dispersedly arranged in a zig-zag shape in a plan view. By performing inspection using a total of 23 inspection pattern sections 34 that are dispersedly arranged in a zig-zag shape in a main surface of the array substrate base material 21M, information regarding the pixel electrodes 23 can be obtained with high accuracy at any position within the display region AA (particularly near the outer circumferential end of the display region AA).

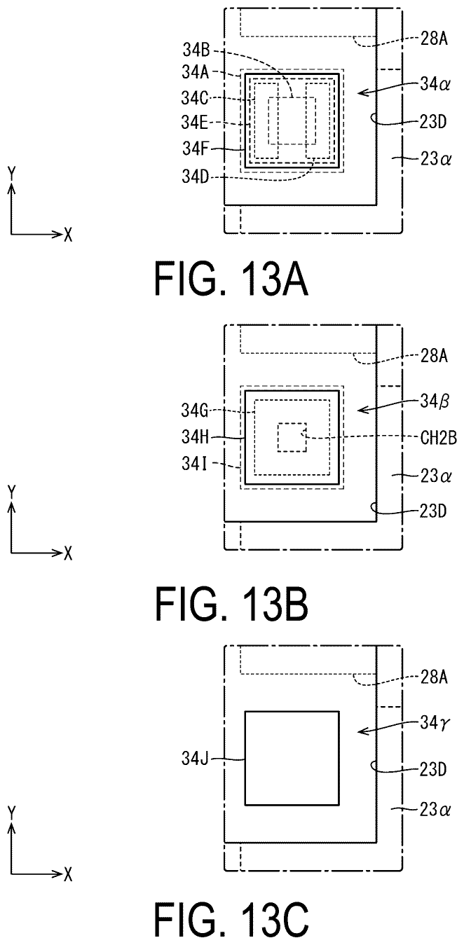

Next, a detailed configuration of the inspection pattern section 34 will be described. In the present embodiment, as illustrated in FIGS. 13A to 13C, the inspection pattern section 34 includes three types of inspection pattern sections; a first inspection pattern section 34α, a second inspection pattern section 34β, and a third inspection pattern section 34γ. The first inspection pattern section 34α, the second inspection pattern section 34β, and the third inspection pattern section 34γ are all substantially square in a plan view, with each side dimension, for example, about 22 μm. The first inspection pattern section 34α, the second inspection pattern section 34β, and the third inspection pattern section 34γ are all formed using various layers and films provided in the array substrate 21. Note that the first inspection pattern section 34α, the second inspection pattern section 34β, and the third inspection pattern section 34γ may be placed in any positions and in any installed number (arrangement ratio) in FIGS. 11 and 12.

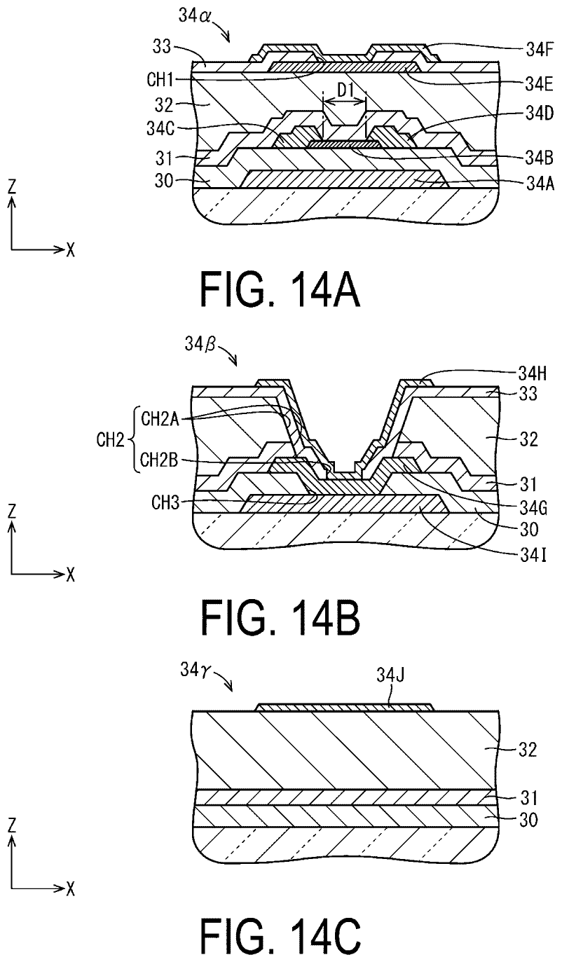

The first inspection pattern section 34α has a configuration as illustrated in FIGS. 13A and 14A. The first inspection pattern section 34α has a layered structure including a first pattern component 34A that is part of the first metal layer, a second pattern component 34B that is part of the semiconductor film, a third pattern component 34C that is part of the second metal layer, a fourth pattern component 34D that is part of the second metal layer, a fifth pattern component 34E that is part of the third metal layer, and a sixth pattern component 34F that is part of the transparent electrode film.

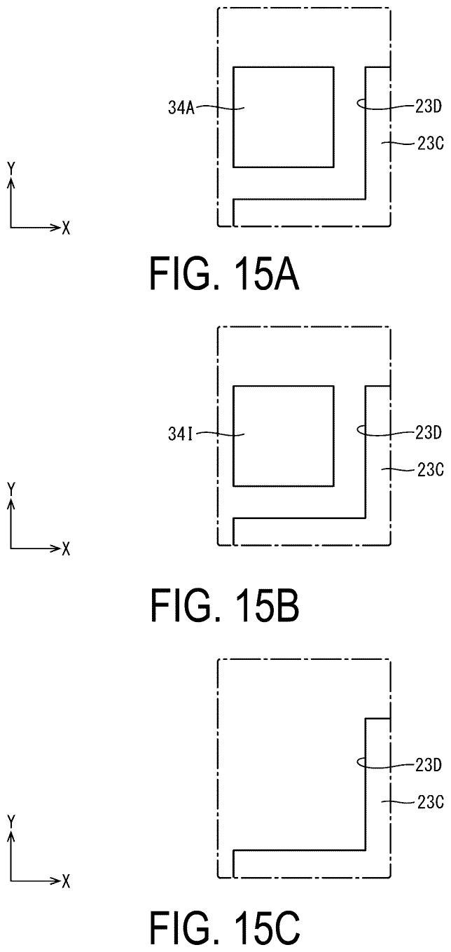

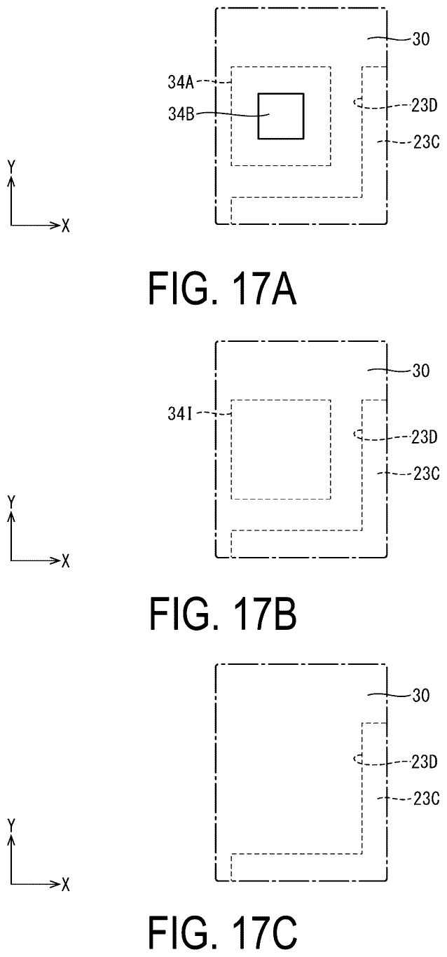

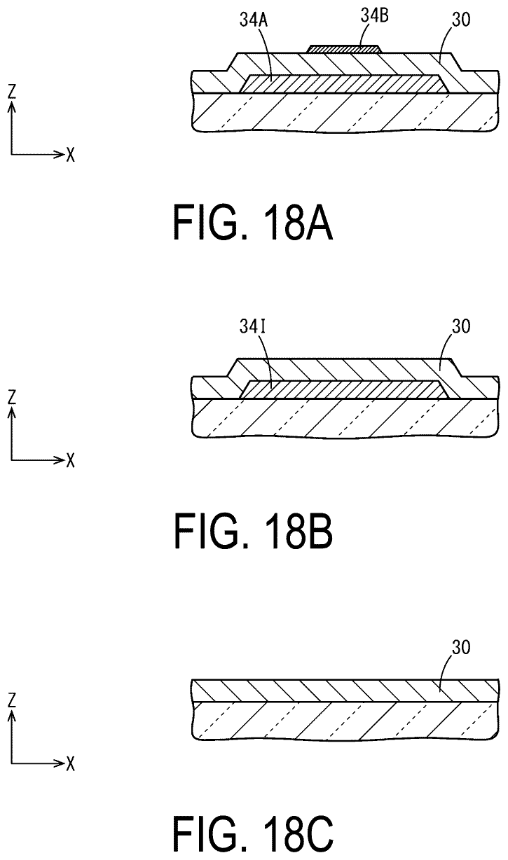

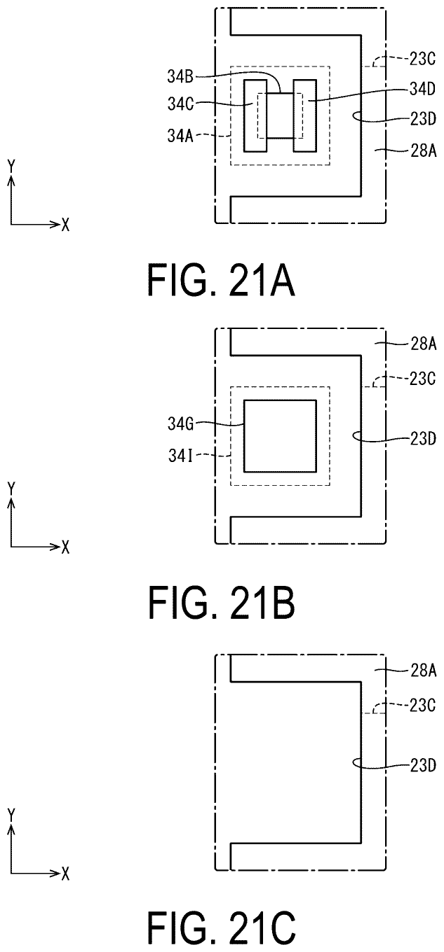

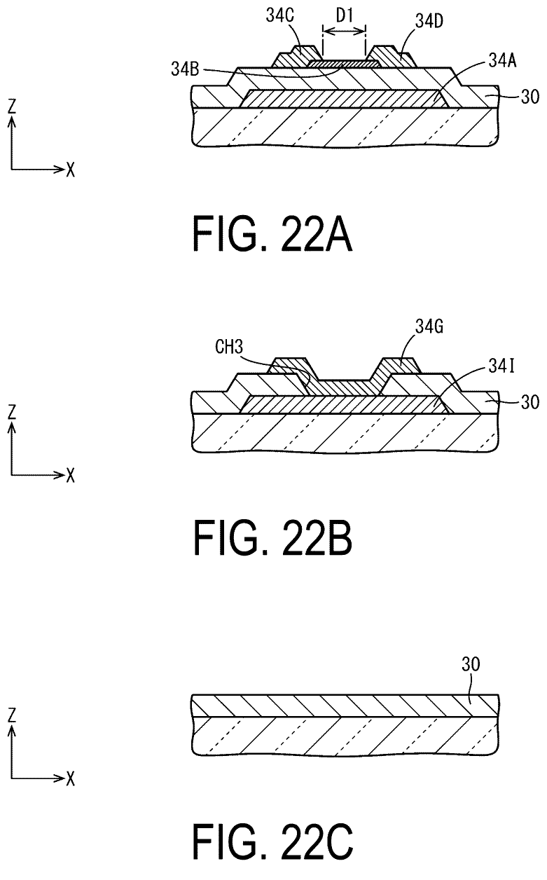

In detail, the first pattern component 34A is substantially square in a plan view, with one side dimension, for example, about 22 μm (see FIG. 15A). The second pattern component 34B is substantially square in a plan view, with one side dimension, for example, about 10 μm, smaller than that of the first pattern component 34A (see FIG. 17A). An entire region of the second pattern component 34B overlaps the first pattern component 34A, with the gate insulating film 30 interposed between the second pattern component 34B and the first pattern component 34A (see FIG. 18A). The third pattern component 34C and the fourth pattern component 34D are both substantially rectangular in a plan view extending along the Y-axis direction, with a long side dimension, for example, about 16 μm, and a short side dimension, for example, about 5 μm (see FIG. 21A). The third pattern component 34C and the fourth pattern component 34D are placed at positions spaced apart, for example, by about 6 μm in the X-axis direction, and this distance coincides with the first distance D1 provided between the source electrode 22B and the drain electrode 22C in the TFT 22 (see FIG. 5). The third pattern component 34C and the fourth pattern component 34D, each are parts of the second metal layer, are directly connected to the second pattern component 34B that is part of the semiconductor film (see FIG. 22A).

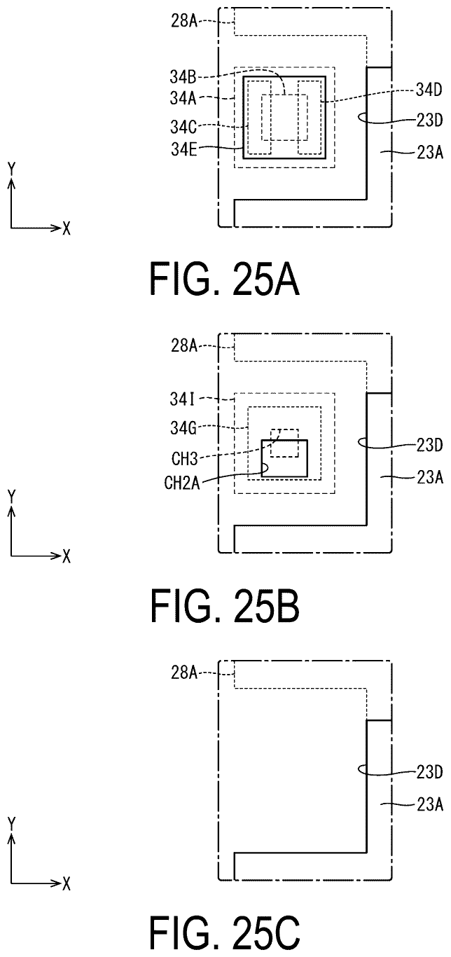

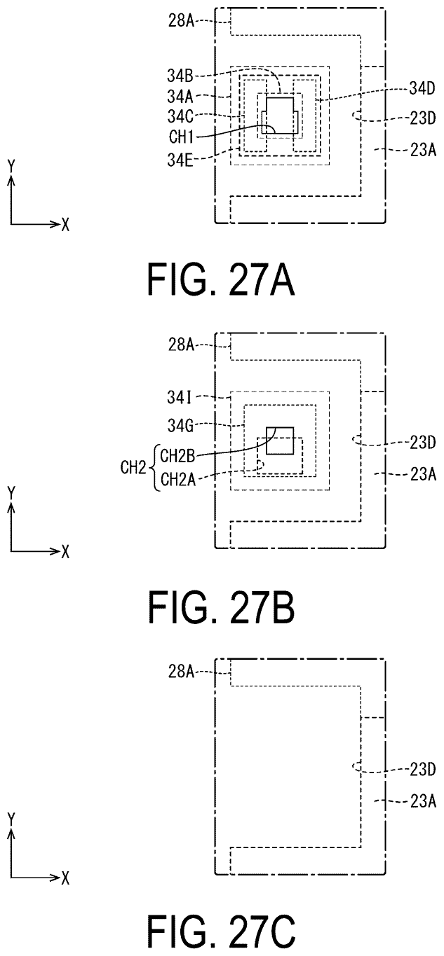

The fifth pattern component 34E is substantially square in a plan view, with one side dimension, for example, about 18 μm, smaller than that of the first pattern component 34A and larger than that of the second pattern component 34B (see FIG. 25A). An entire region of the fifth pattern component 34E overlaps the first pattern component 34A. The sixth pattern component 34F is substantially square in a plan view, with one side dimension, for example, about 20 μm, smaller than that of the first pattern component 34A and larger than those of the second pattern component 34B and the fifth pattern component 34E (see FIG. 13A). Most of the sixth pattern component 34F, excluding an outer circumferential end portion, overlaps the fifth pattern component 34E. As illustrated in FIG. 14A, in the second interlayer insulating film 33 interposed between the fifth pattern component 34E and the sixth pattern component 34F, a first inspection contact hole (second contact hole) CH1 is provided so as to pass through at a position overlapping both the fifth pattern component 34E and the sixth pattern component 34F. The first inspection contact hole CH1 has a substantially square planar shape, with one side dimension, for example, about 8 μm, smaller than those of the fifth pattern component 34E and the sixth pattern component 34F (see FIG. 27A). The planar shape and size (dimension of a side) of the first inspection contact hole CH1 are the same as the planar shape and size of the first pixel contact hole CHP1. The fifth pattern component 34E and the sixth pattern component 34F are connected through the first inspection contact hole CH1. The first pattern component 34A, the second pattern component 34B, the fifth pattern component 34E, and the sixth pattern component 34F, which have a substantially square planar shape in the first inspection pattern section 34α, are arranged concentrically (see FIG. 13A).

As described above, the first pattern component 34A, the second pattern component 34B, the third pattern component 34C, and the fourth pattern component 34D that constitute parts of the first inspection pattern section 34α, as illustrated in FIGS. 13A and 14A, are similar to the gate electrode 22A, the source electrode 22B, the drain electrode 22C, and the semiconductor portion 22D that constitute the TFT 22, which is a structure placed in the display region AA (see FIGS. 4 and 5). Therefore, by inspecting the first pattern component 34A, the second pattern component 34B, the third pattern component 34C, and the fourth pattern component 34D that constitute parts of the first inspection pattern section 34α placed within the opening 23D of the first pixel electrode 23α, it is possible to obtain information related to the position, size, and the like of the gate electrode 22A, the source electrode 22B, the drain electrode 22C, and the semiconductor portion 22D that constitute the TFT 22 with high accuracy. Moreover, the fifth pattern component 34E, the sixth pattern component 34F, and the first inspection contact hole CH1 that constitute parts of the first inspection pattern section 34α are similar to the first pixel electrode component 23A, the second pixel electrode component 23B, and the first pixel contact hole CHP1, which are structures placed in the display region AA (see FIG. 6). Therefore, by inspecting the fifth pattern component 34E, the sixth pattern component 34F, and the first inspection contact hole CH1 that constitute parts of the first inspection pattern section 34α placed within the opening 23D of the first pixel electrode 23α, information related to the position, size, and the like of the first pixel electrode component 23A, the second pixel electrode component 23B, and the first pixel contact hole CHP1 can be obtained with high accuracy.

The second inspection pattern section 34β has a configuration as illustrated in FIGS. 13B and 14B. The second inspection pattern section 34β has a layered structure including a seventh pattern component 34G that is part of the second metal layer, an eighth pattern component 34H that is part of the transparent electrode film, and a ninth pattern component 34I that is part of the first metal layer.

In detail, the ninth pattern component 34I is substantially square in a plan view, with one side dimension, for example, about 22 μm (see FIG. 15B). The seventh pattern component 34G is substantially square in a plan view, with one side dimension, for example, about 16 μm, smaller than that of the ninth pattern component 34I (see FIG. 21B). The eighth pattern component 34H is substantially square in a plan view, with one side dimension, for example, about 20 μm, smaller than that of the ninth pattern component 34I and larger than that of the seventh pattern component 34G (see FIG. 13B).

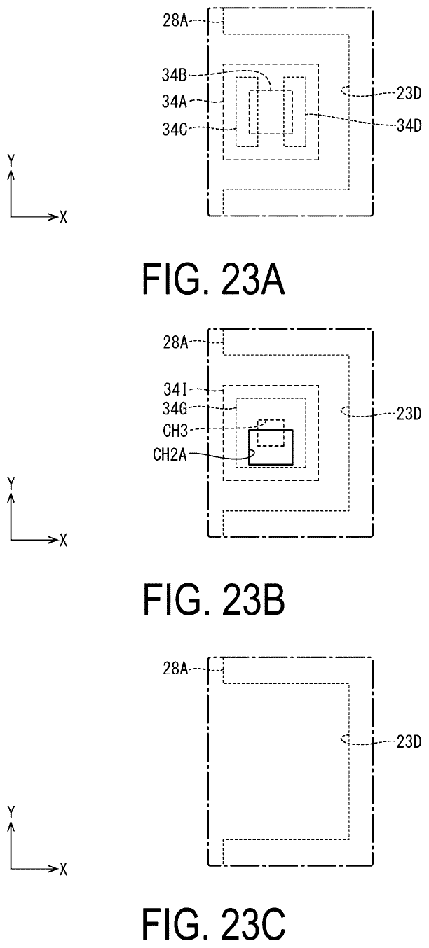

As illustrated in FIG. 14B, in the first interlayer insulating film 31, the flattening film 32, and the second interlayer insulating film 33 interposed between the seventh pattern component 34G and the eighth pattern component 34H, a second inspection contact hole (fourth contact hole) CH2 is provided so as to pass through at a position overlapping both the seventh pattern component 34G and the eighth pattern component 34H. The second inspection contact hole CH2 is formed by communicating a lower side second inspection contact hole CH2A provided in the first interlayer insulating film 31 and the flattening film 32 with an upper side second inspection contact hole CH2B provided in the second interlayer insulating film 33. The lower side second inspection contact hole CH2A has a horizontally elongated, substantially rectangular shape in a plan view, with a long side dimension, for example, about 10 μm, and a short side dimension, for example, about 8 μm (see FIG. 23B). Dimensions of each side of the lower side second inspection contact hole CH2A are smaller than dimensions of each side of the seventh pattern component 34G and the eighth pattern component 34H. The planar shape and size (dimensions of sides) of the lower side second inspection contact hole CH2A are the same as the planar shape and size of the lower side second pixel contact hole CHP2A. The upper side second inspection contact hole CH2B has a substantially square planar shape, with one side dimension, for example, about 8 μm, smaller than those of the seventh pattern component 34G and the eighth pattern component 34H (see FIG. 27B). The planar shape and size (dimension of a side) of the upper side second inspection contact hole CH2B are the same as the planar shape and size of the upper side second pixel contact hole CHP2B. The seventh pattern component 34G and the eighth pattern component 34H are connected through the second inspection contact hole CH2.

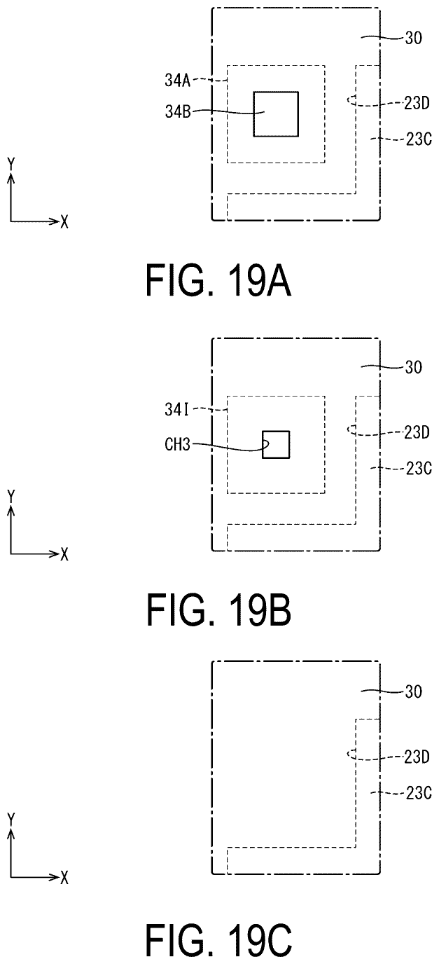

As illustrated in FIG. 14B, in the gate insulating film 30 interposed between the seventh pattern component 34G and the ninth pattern component 34I, a third inspection contact hole (sixth contact hole) CH3 is provided so as to pass through at a position overlapping both the seventh pattern component 34G and the ninth pattern component 34I. The third inspection contact hole CH3 has a substantially square planar shape, with one side dimension, for example, about 6 μm, smaller than those of the seventh pattern component 34G, the ninth pattern component 34I, and the second inspection contact hole CH2 (see FIG. 19B). The seventh pattern component 34G and the ninth pattern component 34I are connected through the third inspection contact hole CH3. The seventh pattern component 34G, the eighth pattern component 34H, and the ninth pattern component 34I, which have a substantially square planar shape in the second inspection pattern section 34β, are arranged concentrically (see FIG. 13B).

As described above, the seventh pattern component 34G, the eighth pattern component 34H, and the second inspection contact hole CH2 that constitute parts of the second inspection pattern section 34β, as illustrated in FIGS. 13B and 14B, are similar to the drain electrode 22C, the second pixel electrode component 23B, and the second pixel contact hole CHP2, which are structures placed in the display region AA (see FIG. 5). Therefore, by inspecting the seventh pattern component 34G, the eighth pattern component 34H, and the lower side second inspection contact hole CH2A that constitute parts of the second inspection pattern section 34β placed within the opening 23D of the first pixel electrode 23α, information related to the position, size, and the like of the drain electrode 22C, the second pixel electrode component 23B, and the second pixel contact hole CHP2 can be obtained with high accuracy. Moreover, the seventh pattern component 34G, the ninth pattern component 34I, and the third inspection contact hole CH3 that constitute parts of the second inspection pattern section 34β are similar to the drain electrode 22C, the third pixel electrode component 23C, and the third pixel contact hole CHP3, which are structures placed in the display region AA (see FIG. 5). Therefore, by inspecting the seventh pattern component 34G, the ninth pattern component 34I, and the third inspection contact hole CH3 that constitute parts of the second inspection pattern section 34β placed within the opening 23D of the first pixel electrode 23α, information related to the position, size, and the like of the drain electrode 22C, the third pixel electrode component 23C, and the third pixel contact hole CHP3 can be obtained with high accuracy.

The third inspection pattern section 34γ has a configuration as illustrated in FIGS. 13C and 14C. The third inspection pattern section 34γ is a 10th pattern component 34J that is part of the transparent electrode film. In detail, the 10th pattern component 34J is substantially square in a plan view, with one side dimension, for example, about 20 μm. The 10th pattern component 34J is layered on the flattening film 32. That is, the third inspection pattern section 34γ differs from the first inspection pattern section 34α and the second inspection pattern section 34β in which an underlayer of the sixth pattern component 34F and the eighth pattern component 34H is the second interlayer insulating film 33, in that the second interlayer insulating film 33 is removed and an underlayer of the 10th pattern component 34J is the flattening film 32.

The array substrate 21 according to the present embodiment has the structure described above. Next, a method of manufacturing the array substrate 21 will be described. The method of manufacturing the array substrate 21 includes the following steps: a first step of depositing and patterning the first metal layer; a second step of depositing the gate insulating film 30; a third step of depositing and patterning the semiconductor film; a fourth step of patterning the gate insulating film 30; a fifth step of depositing and patterning the second metal layer; a sixth step of depositing and patterning the first interlayer insulating film 31 and the flattening film 32; a seventh step of depositing and patterning the third metal layer; an eighth step of depositing and patterning the second interlayer insulating film 33; and a ninth step of depositing and patterning the transparent electrode film. Among the first to ninth steps described above, in each of the first to ninth steps except the second step (the first step and the third to the ninth steps), a photomask, an exposure device, and the like are used for patterning, and an inspection step is performed after each step is completed.

The term “patterning” described above means processing of a film based on a general photolithography method. Specifically, the processing of a film to be processed, that is, the patterning, is performed by depositing a photoresist film on the film to be processed, exposing the photoresist film with an exposure device through a photomask having a predetermined opening pattern, and then developing the photoresist film, and performing etching through the developed photoresist film.

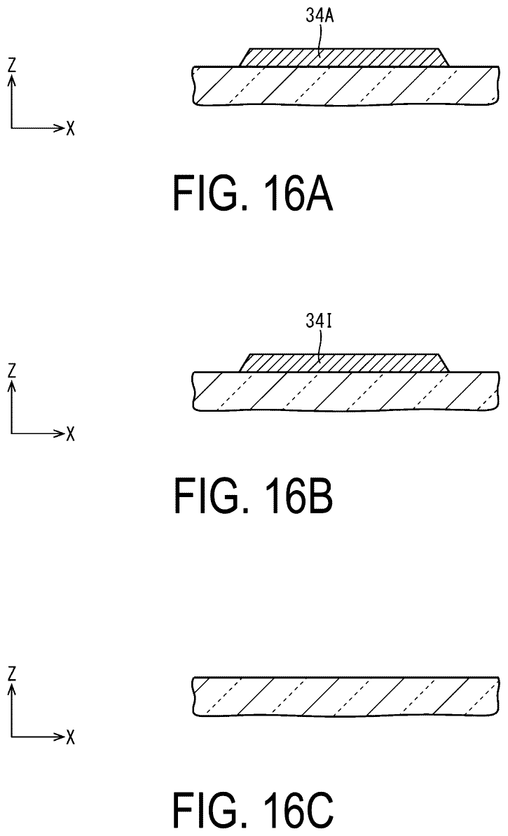

In the first step, the first metal layer is deposited on the glass substrate (array substrate base material 21M), and the first metal layer is selectively etched by photolithography. As a result, in the display region AA, the gate electrode 22A of the TFT 22, the third pixel electrode component 23C of the pixel electrode 23, the gate wiring line 24, and the like are formed (see FIG. 5), and as illustrated in FIGS. 15A to 16C, the first pattern component 34A constituting part of the first inspection pattern section 34α and the ninth pattern component 34I constituting part of the second inspection pattern section 34β are formed.

After the first step is finished, the inspection step is performed. In this inspection step, the first pattern component 34A constituting part of the first inspection pattern section 34α is inspected. The position, size (dimensions of sides), and the like of the first pattern component 34A are measured, and the measured values are compared with target values. Thus, information related to the positions, sizes, and the like of the structures (the gate electrode 22A, the third pixel electrode component 23C, and the gate wiring line 24) that are parts of the first metal layer in the display region AA can be obtained with high accuracy.

In the second step, the gate insulating film 30 is deposited on the first metal layer. In the subsequent third step, the semiconductor film is deposited on the gate insulating film 30, and the semiconductor film is selectively etched by photolithography. As a result, in the display region AA, the semiconductor portion 22D of the TFT 22 is formed (see FIG. 5), and, as illustrated in FIGS. 17A to 18C, the second pattern component 34B constituting part of the first inspection pattern section 34α is formed.

After the third step is finished, the inspection step is performed. In this inspection step, the second pattern component 34B constituting part of the first inspection pattern section 34α is inspected. The position, size (dimensions of sides), and the like of the second pattern component 34B are measured, and the measured values are compared with target values. Thus, information related to the position, size, and the like of a structure (the semiconductor portion 22D) that is part of the semiconductor film in the display region AA can be obtained with high accuracy.

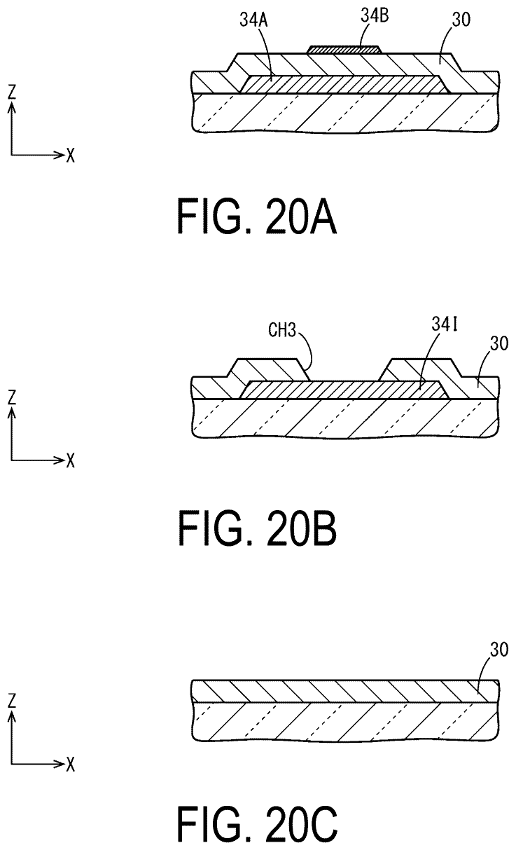

In the fourth step, the gate insulating film 30 is selectively etched by photolithography. As a result, in the display region AA, the third pixel contact hole CHP3 and the gate contact hole CHG are formed (see FIGS. 5 and 9), and, as illustrated in FIGS. 19A to 20C, the third inspection contact hole CH3 constituting part of the second inspection pattern section 34β is formed.

After the fourth step is finished, the inspection step is performed. In this inspection step, the third inspection contact hole CH3 constituting part of the second inspection pattern section 34β is inspected. The position, size (dimensions of sides), and the like of the third inspection contact hole CH3 are measured, and the measured values are compared with target values. Thus, information related to the positions, the sizes, and the like of the structures (the third pixel contact hole CHP3 and the gate contact hole CHG) formed by etching the gate insulating film 30 in the display region AA can be obtained with high accuracy.

In the fifth step, the second metal layer is deposited, and then selectively etched by photolithography. As a result, in the display region AA, the source electrode 22B, the drain electrode 22C, the source wiring line 25, the gate connection wiring line 27, and the capacitance electrode main body 28A are formed (see FIG. 5), and as illustrated in FIGS. 21A to 22C, the third pattern component 34C and the fourth pattern component 34D constituting part of the first inspection pattern section 34α, and the seventh pattern component 34G constituting part of the second inspection pattern section 34β are formed.

After the fifth step is finished, the inspection step is performed. In this inspection step, the third pattern component 34C and the fourth pattern component 34D constituting parts of the first inspection pattern section 34α, and the seventh pattern component 34G constituting part of the second inspection pattern section 34β are inspected. The positions, sizes (dimensions of sides), and the like of the third pattern component 34C and the fourth pattern component 34D constituting parts of the first inspection pattern section 34α are measured, and the measured values are compared with target values. Thus, information related to the positions, sizes, and the like (particularly the dimension of the first distance D1) of the structures of the TFT 22 (the source electrode 22B and the drain electrode 22C) that are parts of the second metal layer in the display region AA can be obtained with high accuracy. Similarly, the position, size (dimensions of sides), and the like of the seventh pattern component 34G constituting part of the second inspection pattern section 34β are measured, and the measured values are compared with target values. Thus, information related to the positions, sizes, and the like of structures other than the TFT 22 (the source wiring line 25, the gate connection wiring line 27, and the capacitance electrode main body 28A) that are parts of the second metal layer in the display region AA, can be obtained with high accuracy.

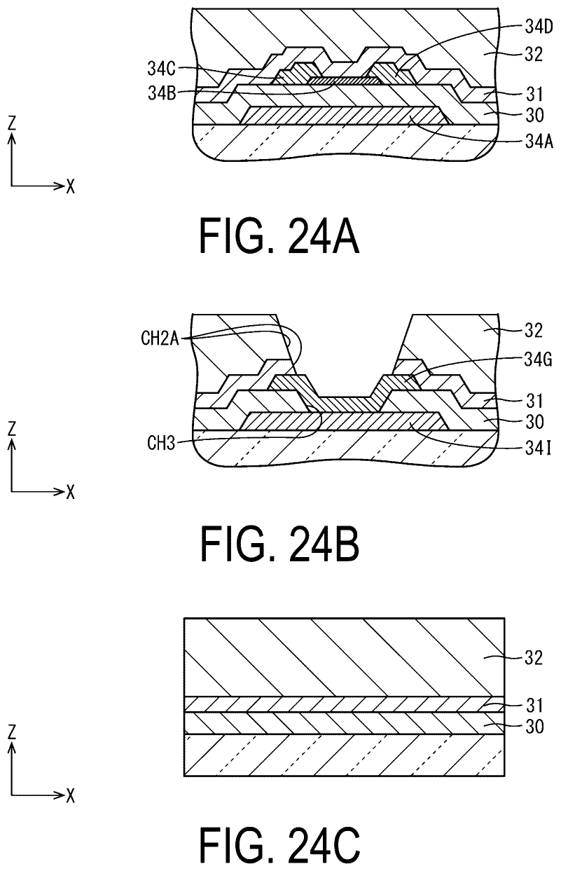

In the sixth step, the first interlayer insulating film 31 and the flattening film 32 are successively deposited, and the first interlayer insulating film 31 and the flattening film 32 are selectively etched together by photolithography. As a result, in the display region AA, the lower side second pixel contact hole CHP2A included in the second pixel contact hole CHP2, the first capacitance contact hole CHC1 and the second capacitance contact hole CHC2 are formed (see FIGS. 5, 7, and 8), and, as illustrated in FIGS. 23A to 24C, the lower side second inspection contact hole CH2A included in the second inspection contact hole CH2 constituting part of the second inspection pattern section 34β is formed.

After the sixth step is finished, the inspection step is performed. In this inspection step, the lower side second inspection contact hole CH2A constituting part of the second inspection pattern section 34β is inspected. The position, size (dimensions of sides), and the like of the lower side second inspection contact hole CH2A are measured, and the measured values are compared with target values. Thus, information related to the positions, sizes, and the like of the structures (the lower side second pixel contact hole CHP2A, the first capacitance contact hole CHC1, and the second capacitance contact hole CHC2) formed by etching the first interlayer insulating film 31 and the flattening film 32 in the display region AA can be obtained with high accuracy.

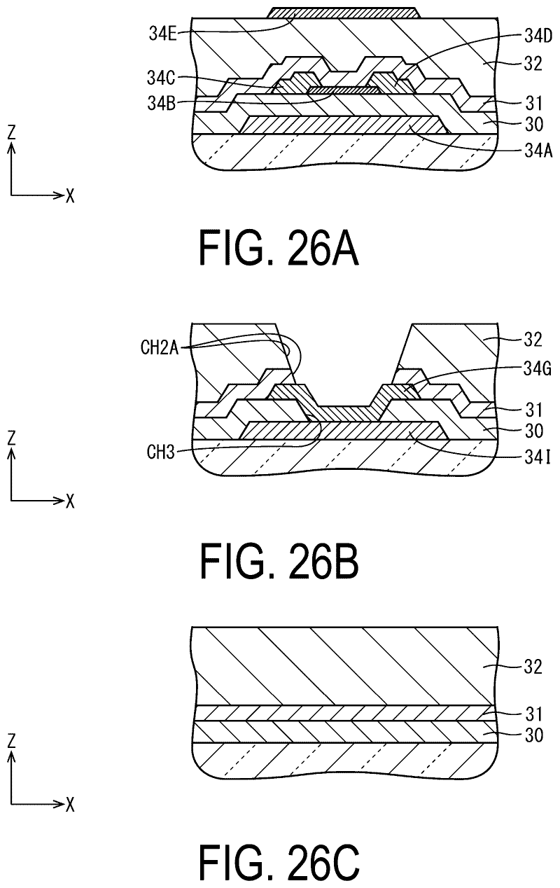

In the seventh step, the third metal layer is deposited, and then selectively etched by photolithography. As a result, in the display region AA, the first pixel electrode component 23A, the capacitance branch wiring line 26, and the covering portion 28B are formed (see FIGS. 5 and 8), and, as illustrated in FIGS. 25A to 26C, the fifth pattern component 34E constituting part of the first inspection pattern section 34α is formed.

After the seventh step is finished, the inspection step is performed. In this inspection step, the fifth pattern component 34E constituting part of the first inspection pattern section 34α is inspected. The position, size (dimensions of sides), and the like of the fifth pattern component 34E are measured, and the measured values are compared with target values. Thus, information related to the positions, sizes, and the like of structures (the first pixel electrode component 23A, the capacitance branch wiring line 26, and the covering portion 28B) that are parts of the third metal layer in the display region AA, can be obtained with high accuracy.

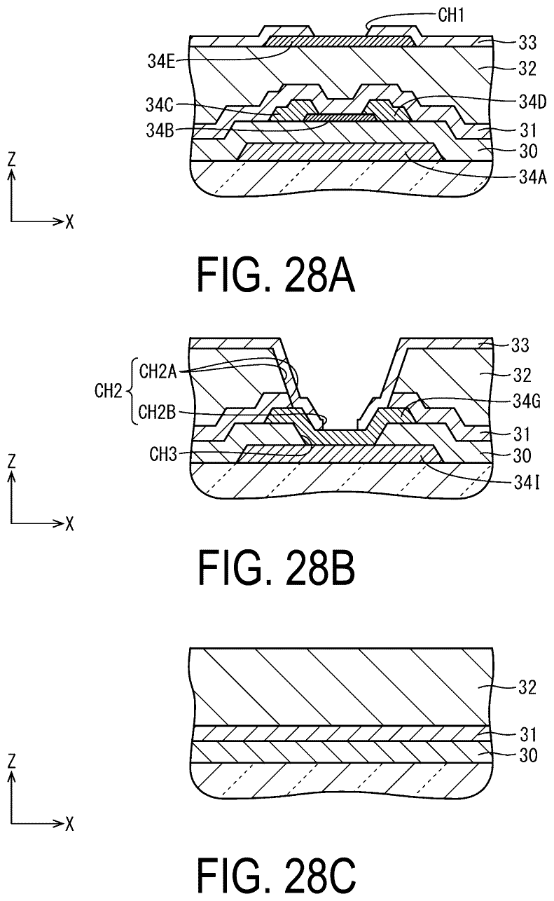

In the eighth step, the second interlayer insulating film 33 is deposited, and then selectively etched by photolithography. Thus, in the display region AA, the first pixel contact hole CHP1 and the upper side second pixel contact hole CHP2B included in the second pixel contact hole CHP2 are formed (see FIGS. 5 and 6), and as illustrated in FIGS. 27A to 28C, the first inspection contact hole CH1 constituting part of the first inspection pattern section 34α and the upper side second inspection contact hole CH2B included in the second inspection contact hole CH2 constituting part of the second inspection pattern section 34β are formed.

After the eighth step is finished, the inspection step is performed. In this inspection step, the first inspection contact hole CH1 constituting part of the first inspection pattern section 34α and the upper side second inspection contact hole CH2B constituting part of the second inspection pattern section 34β and overlapping the lower side second inspection contact hole CH2A are inspected. The position, size (dimensions of sides), and the like of the first inspection contact hole CH1 constituting part of the first inspection pattern section 34α are measured, and the measured values are compared with target values. Thus, information related to the position, size, and the like of the structure (the first pixel contact hole CHP1) formed by etching the second interlayer insulating film 33 in the display region AA can be obtained with high accuracy. Similarly, the position, size (dimensions of sides), and the like of the upper side second inspection contact hole CH2B constituting part of the second inspection pattern section 34β are measured, and the measured values are compared with target values. Thus, by etching the second interlayer insulating film 33 in the display region AA, information related to the position, size, and the like of the structure (the upper side second pixel contact hole CHP2B) formed to overlap the lower side second pixel contact hole CHP2A can be obtained with high accuracy.

In the ninth step, the transparent electrode film is deposited and then selectively etched by photolithography. As a result, in the display region AA, the second pixel electrode component 23B is formed (see FIG. 5), and as illustrated in FIGS. 13A to 14C, the sixth pattern component 34F constituting part of the first inspection pattern section 34α and the eighth pattern component 34H constituting part of the third inspection pattern section 34γ are formed.

After the ninth step is finished, the inspection step is performed. In this inspection step, the sixth pattern component 34F constituting part of the first inspection pattern section 34α and the eighth pattern component 34H constituting part of the third inspection pattern section 34γ are inspected. The position, size (dimensions of sides), and the like of the sixth pattern component 34F constituting part of the first inspection pattern section 34α are measured, and the measured values are compared with target values. Thus, information related to the position, size, and the like of a structure (second pixel electrode component 23B) that is part of the transparent electrode film in the display region AA can be obtained with high accuracy. Similarly, the position, size (dimensions of sides), and the like of the eighth pattern component 34H constituting part of the third inspection pattern section 34γ are measured, and the measured values are compared with target values. Thus, information regarding differences in position and size caused by different underlayers (the second interlayer insulating film 33 and the flattening film 32) between the sixth pattern component 34F and the eighth pattern component 34H can be obtained with high accuracy. In this way, the array substrate 21 is manufactured.

As described above, the array substrate (display substrate) 21 of the present embodiment includes the plurality of pixel electrodes 23 placed in the display region AA and the inspection pattern section 34 that is part of the conductive layers constituting the pixel electrodes 23, and in the plurality of pixel electrodes 23, there is the first pixel electrode 23α having the opening 23D, and the inspection pattern section 34 is placed within the opening 23D of the first pixel electrode 23α.

In the plurality of pixel electrodes 23 placed in the display region AA, there is the first pixel electrode 23α having the opening 23D. The inspection pattern section 34 that is part of the conductive layers that constitute the pixel electrode 23 is placed within the opening 23D of the first pixel electrode 23α, so that by inspecting the inspection pattern section 34, it is possible to obtain information related to the positions, dimensions, and the like in the pixel electrode 23. Compared to the existing method of performing inspection using only the inspection pattern section 34 located outside the display region AA, inspection accuracy is improved, and information regarding the pixel electrode 23, which is a structure located in the display region AA, can be obtained with high accuracy.

The array substrate 21 includes the thin film transistors (TFTs) 22 placed in the display region AA and connected to the plurality of pixel electrodes 23, and the gate insulating film (first insulating film) 30, in which each of the TFTs 22 includes the gate electrode 22A being part of the first metal layer placed below the gate insulating film 30, the semiconductor portion 22D being part of the semiconductor film placed above the gate insulating film 30 and overlapping the gate electrode 22A, the source electrode 22B being part of the second metal layer placed above the semiconductor film and connected to the semiconductor portion 22D, and the drain electrode 22C being part of the second metal layer, positioned at the first distance D1 from the source electrode 22B, and connected to the semiconductor portion 22D and one of the plurality of pixel electrodes 23, and the inspection pattern section 34 includes the first inspection pattern section 34α including the first pattern component 34A being part of the first metal layer, the second pattern component 34B being part of the semiconductor film and overlapping the first pattern component 34A, the third pattern component 34C being part of the second metal layer and connected to the second pattern component 34B, and the fourth pattern component 34D being part of the second metal layer, positioned at the first distance D1 from the third pattern component 34C, and connected to the second pattern component 34B. By inspecting the first pattern component 34A, the second pattern component 34B, the third pattern component 34C, and the fourth pattern component 34D that constitute parts of the first inspection pattern section 34α placed within the opening 23D of the first pixel electrodes 23α, it is possible to obtain information related to the position, size, and the like of the gate electrode 22A, the source electrode 22B, the drain electrode 22C, and the semiconductor portion 22D that constitute the TFT 22 with high accuracy.

The array substrate 21 includes the first interlayer insulating film 31 and the flattening film 32 both being the second insulating film placed above the second metal layer, the first pixel electrode component 23A placed above the flattening film 32 being the second insulating film, being part of the third metal layer, the third metal layer being one of the conductive layers, and constituting part of one of the plurality of pixel electrodes 23, the second interlayer insulating film (third insulating film) 33 placed above the third metal layer, and the second pixel electrode component 23B placed above the second interlayer insulating film 33, being part of the transparent electrode film, the transparent electrode film being one of the conductive layers, constituting part of one of the plurality of pixel electrodes 23, and overlapping the first pixel electrode component 23A, in which the first inspection pattern section 34α includes the fifth pattern component 34E being part of the third metal layer and overlapping at least the first pattern component 34A, and the sixth pattern component 34F being part of the transparent electrode film and overlapping the fifth pattern component 34E, and the first pixel contact hole (first contact hole) CHP1 configured to connect the first pixel electrode component 23A and the second pixel electrode component 23B is provided in the first interlayer insulating film 31 and the flattening film 32 both being the second insulating film at the position overlapping both the first pixel electrode component 23A and the second pixel electrode component 23B, and the first inspection contact hole (second contact hole) CH1 configured to connect the fifth pattern component 34E and the sixth pattern component 34F is provided in the first interlayer insulating film 31 and the flattening film 32 both being the second insulating film at the position overlapping both the fifth pattern component 34E and the sixth pattern component 34F. By inspecting the fifth pattern component 34E, the sixth pattern component 34F, and the first inspection contact hole CH1 of the first inspection pattern section 34α, information related to the position, size, and the like of the first pixel electrode component 23A, the second pixel electrode component 23B, and the first pixel contact hole CHP1 can be obtained with high accuracy.

The inspection pattern section 34 includes the second inspection pattern section 34β including the seventh pattern component 34G being part of the second metal layer and the eighth pattern component 34H being part of the transparent electrode film and overlapping the seventh pattern component 34G, and the second pixel contact hole (third contact hole) CHP2 configured to connect the second pixel electrode component 23B and the drain electrode 22C is provided in the first interlayer insulating film 31 and the flattening film 32 both being the second insulating film, and the second interlayer insulating film 33 at the position overlapping both the second pixel electrode component 23B and the drain electrode 22C, and the second inspection contact hole (fourth contact hole) CH2 configured to connect the seventh pattern component 34G and the eighth pattern component 34H is provided in the first interlayer insulating film 31 and the flattening film 32 both being the second insulating film, and the second interlayer insulating film 33 at the position overlapping both the seventh pattern component 34G and the eighth pattern component 34H. By inspecting the seventh pattern component 34G, the eighth pattern component 34H, and the second inspection contact hole CH2 of the second inspection pattern section 34β, information related to the positions, sizes, and the like of the second pixel electrode component 23B, the drain electrode 22C, and the second pixel contact hole CHP2 can be obtained with high accuracy.

The array substrate 21 includes the third pixel electrode component 23C being part of the first metal layer, the first metal layer being one of the conductive layers, constituting part of one of the plurality of pixel electrodes 23, and overlapping part of the drain electrode 22C, in which the second inspection pattern section 34β includes the ninth pattern component 34I being part of the first metal layer and overlapping the seventh pattern component 34G, and the third pixel contact hole (fifth contact hole) CHP3 configured to connect the third pixel electrode component 23C and the drain electrode 22C is provided in the gate insulating film 30 at the position overlapping both the third pixel electrode component 23C and the drain electrode 22C, and the third inspection contact hole (sixth contact hole) CH3 configured to connect the seventh pattern component 34G and the ninth pattern component 34I is provided in the gate insulating film 30 at the position overlapping both the seventh pattern component 34G and the ninth pattern component 34I. By inspecting the seventh pattern component 34G, the ninth pattern component 34I, and the third inspection contact hole CH3 of the second inspection pattern section 34β, information related to the positions, sizes, and the like of the third pixel electrode component 23C, the drain electrode 22C, and the third pixel contact hole CHP3 can be obtained with high accuracy.

The electronic paper display (display device) 10 according to the present embodiment includes the array substrate 21 described above, the counter substrate 20 placed facing the array substrate 21, and the microcapsule layer (display layer) MCR sandwiched between the array substrate 21 and the counter substrate 20 and configured to display an image. Such an electronic paper display 10 improves inspection accuracy of the array substrate 21, and enables highly accurate acquisition of information regarding the pixel electrodes 23, which is a structure placed in the display region AA of the array substrate 21, thereby improving a yield rate.

The display layer is the microcapsule layer (electronic paper layer) MCR including the plurality of microcapsules MC or micro-cups containing charged particles, and the plurality of pixel electrodes 23 overlap the plurality of microcapsules MC or micro-cups, respectively. The charged particles contained in the plurality of microcapsules MC or micro-cups can be made to flow in response to the voltage applied to the plurality of pixel electrodes 23. Accordingly, a predetermined image is displayed on the microcapsule layer MCR.

### Other Embodiments

The techniques disclosed herein are not limited to the embodiments described above and illustrated in the drawings, and the following embodiments, for example, are also included within the technical scope.
(1) The position and size of the opening 23D provided in the first pixel electrode 23α may be changed as appropriate other than those illustrated in the drawings. In accordance with changing the position and size of the opening 23D in the first pixel electrode 23α, the position and size of the inspection pattern section 34 may be changed.
(2) The specific positions and number of inspection pattern sections 34 placed in the display region AA of the array substrate 21 may be changed as appropriate other than those illustrated in the drawings. Similarly, the specific positions and number of inspection pattern sections 34 placed in the pattern arrangement region PA of the array substrate base material 21M may be changed as appropriate other than those illustrated in the drawings.
(3) The specific installed number and ratio of the three types of the inspection pattern sections 34α to 34γ may be set as appropriate.
(4) The number of types of the inspection pattern sections 34 may be two or less, or four or more. For example, it is possible to omit the third inspection pattern section 34γ and use only the first inspection pattern section 34α and the second inspection pattern section 34β. For example, a fourth inspection pattern section may be provided, which includes an 11th pattern component that is part of the second metal layer, a 12th pattern component that is part of the third metal layer and overlaps the 11th pattern component, and a fourth inspection contact hole provided in the first interlayer insulating film 31 and the flattening film 32 at a position overlapping both the 11th pattern component and the 12th pattern component. By inspecting the fourth inspection pattern section, information regarding the capacitance electrode main body 28A, the covering portion 28B, and the first capacitance contact hole CHC1, and information regarding the capacitance branch wiring line 26, the capacitance electrode main body 28A, and the second capacitance contact hole CHC2 can be obtained with high accuracy.
(5) The gate wiring line 24 may be provided for each row formed by the plurality of pixel electrodes 23 arranged along the X-axis direction. In this case, the number of gate wiring lines 24 installed is equal to the number of rows of the pixel electrodes 23. Accordingly, the source wiring line 25 may be provided for each column formed by the plurality of pixel electrodes 23 arranged along the Y-axis direction, and the number of source wiring lines 25 installed may be equal to the number of columns of the pixel electrodes 23. Note that the capacitance branch wiring line 26 is placed to overlap a predetermined gate wiring line 24. The number of gate connection wiring lines 27 installed may be changed according to the number of gate wiring lines 24 installed.
(6) The array substrate 21 may be provided with an inspection wiring line for inspecting the gate wiring line 24 for breaks or the like. The inspection wiring line is placed in the non-display region NAA and is connected to an end of the gate wiring line 24.
(7) The array substrate 21 may be provided with a source driver that supplies image signals to the source wiring line 25 and a gate driver that supplies scanning signals to the gate connection wiring line 27.
(8) It is also possible to omit the gate connection wiring lines 27 provided across the display region AA, and provide a gate drive circuit connected to the end of the gate wiring line 24 in the non-display region NAA. The gate drive circuit directly supplies a scanning signal to the gate wiring line 24. Note that a gate driver can be used instead of the gate drive circuit.
(9) The material of the semiconductor film constituting the semiconductor portion 22D and the like may be polysilicon (LTPS), amorphous silicon, or the like.
(10) In the counter substrate 20 and the array substrate 21, instead of the glass substrates, resin substrates made of a synthetic resin may be used.
(11) The driver 11 may be mounted on the flexible substrate 12 using chip on film (COF).
(12) The planar shape of the electronic paper display 10 may be a horizontally long rectangle, a square, a circle, a semicircle, a vertically long oval, an ellipse, a trapezoid, or the like.
(13) The electronic paper display 10 may be operated using a micro-cup electrophoretic method. The micro-cup electrophoretic electronic paper display 10 has an electronic paper layer having the following configuration. That is, the electronic paper layer includes a substrate having micro-cups, a sealing portion attached to the substrate so as to seal the micro-cups, and a counter electrode layered on a front side of the substrate. The substrate is made of a transparent synthetic resin material or the like, and has micro-cups that open toward the back. In detail, the substrate includes partitions that form a lattice pattern in a plan view, and spaces partitioned by these partitions form the micro-cups. A plurality of micro-cups are arranged in a matrix in a plane within the main surface of the substrate. The plurality of micro-cups are arranged so as to overlap the pixel electrodes 23 provided in the array substrate 21. The micro-cups contain positively charged particles and negatively charged particles together with an insulating fluid that is silicone oil. With such a configuration, the electronic paper display 10 can achieve actions and effects similar to those in the first embodiment described above.
(14) In addition to the above (13), the operation method of the electronic paper display 10 may be changed as appropriate to an electronic liquid powder method, an electrowetting method, a cholesteric liquid crystal method, or the like.
(15) A display device other than the electronic paper display 10 (e.g., a liquid crystal panel or an organic EL display panel) may be used.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A display substrate comprising:
a plurality of pixel electrodes placed in a display region; and
an inspection pattern section being part of conductive layers constituting the plurality of pixel electrodes,
wherein in the plurality of pixel electrodes, there is a first pixel electrode having an opening, and
the inspection pattern section is placed within the opening of the first pixel electrode.

2. The display substrate according to claim 1, comprising:
thin film transistors placed in the display region and connected to the plurality of pixel electrodes; and
a first insulating film,
wherein each of the thin film transistors includes a gate electrode being part of a first metal layer placed below the first insulating film, a semiconductor portion being part of a semiconductor film placed above the first insulating film and overlapping the gate electrode, a source electrode being part of a second metal layer placed above the semiconductor film and connected to the semiconductor portion, and a drain electrode being part of the second metal layer, positioned at a first distance from the source electrode, and connected to the semiconductor portion and one of the plurality of pixel electrodes, and
the inspection pattern section includes a first inspection pattern section including a first pattern component being part of the first metal layer, a second pattern component being part of the semiconductor film and overlapping the first pattern component, a third pattern component being part of the second metal layer and connected to the second pattern component, and a fourth pattern component being part of the second metal layer, positioned at the first distance from the third pattern component, and connected to the second pattern component.

3. The display substrate according to claim 2, comprising:
a second insulating film placed above the second metal layer;
a first pixel electrode component placed above the second insulating film, being part of a third metal layer, the third metal layer being one of the conductive layers, and constituting part of one of the plurality of pixel electrodes;
a third insulating film placed above the third metal layer; and
a second pixel electrode component placed above the third insulating film, being part of a transparent electrode film, the transparent electrode film being one of the conductive layers, constituting part of one of the plurality of pixel electrodes, and overlapping the first pixel electrode component,
wherein the first inspection pattern section includes a fifth pattern component being part of the third metal layer and overlapping at least the first pattern component, and a sixth pattern component being part of the transparent electrode film and overlapping the fifth pattern component, and
a first contact hole configured to connect the first pixel electrode component and the second pixel electrode component is provided in the second insulating film at a position overlapping both the first pixel electrode component and the second pixel electrode component, and a second contact hole configured to connect the fifth pattern component and the sixth pattern component is provided in the second insulating film at a position overlapping both the fifth pattern component and the sixth pattern component.

4. The display substrate according to claim 3,
wherein the inspection pattern section includes a second inspection pattern section including a seventh pattern component being part of the second metal layer and an eighth pattern component being part of the transparent electrode film and overlapping the seventh pattern component, and
a third contact hole configured to connect the second pixel electrode component and the drain electrode is provided in the second insulating film and the third insulating film at a position overlapping both the second pixel electrode component and the drain electrode, and a fourth contact hole configured to connect the seventh pattern component and the eighth pattern component is provided in the second insulating film and the third insulating film at a position overlapping both the seventh pattern component and the eighth pattern component.

5. The display substrate according to claim 4, comprising:
a third pixel electrode component being part of the first metal layer, the first metal layer being one of the conductive layers, constituting part of one of the plurality of pixel electrodes, and overlapping part of the drain electrode,
wherein the second inspection pattern section includes a ninth pattern component being part of the first metal layer and overlapping the seventh pattern component, and
a fifth contact hole configured to connect the third pixel electrode component and the drain electrode is provided in the first insulating film at a position overlapping both the third pixel electrode component and the drain electrode, and a sixth contact hole configured to connect the seventh pattern component and the ninth pattern component is provided in the first insulating film at a position overlapping both the seventh pattern component and the ninth pattern component.

6. A display device comprising:
the display substrate according to claim 1;
a counter substrate placed facing the display substrate; and
a display layer sandwiched between the display substrate and the counter substrate and configured to display an image.

7. The display device according to claim 6,
wherein the display layer is an electronic paper layer including a plurality of microcapsules or micro-cups including charged particles, and
the plurality of pixel electrodes overlap the plurality of microcapsules or micro-cups, respectively.
